(19) United States
(12) Patent Application Publication
(10) Pub. No.: US 2008/0082828 A1
(43) Pub. Date: Apr. 3, 2008

(54) CIRCUIT ARRANGEMENT AND METHOD FOR STARTING UP A CIRCUIT ARRANGEMENT

(75) Inventors: Gerard David Jennings, Munich (DE); Hans Brandl, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/865,205

(22) Filed: Oct. 1, 2007

(30) Foreign Application Priority Data
Sep. 29, 2006 (DE) 10 2006 046 456.7

(51) Int. Cl. H04L 9/32; H04L 9/14; H04L 9/30

(52) U.S. Cl. 713/176; 713/191; 726/17

(57) ABSTRACT

A circuit arrangement has a crypto unit which provides at least one cryptographic function. An access monitoring interface is also provided in order to check an access request from an application computer program to a cryptographic function of the crypto unit. The access monitoring interface is designed such that it checks whether the application computer program is authorized to access the cryptographic function, and the cryptographic function is called only if it is authorized to do so.

### CROSS-REFERENCE TO RELATED APPLICATION

This application claims priority to German Patent Application Serial No. 10 2006 046 456.7, which was filed Sep. 29, 2006, and is incorporated herein by reference in its entirety.

### TECHNICAL FIELD

Embodiments of the invention generally relate to a circuit arrangement, to a method for starting up a circuit arrangement, to a method for operating a circuit arrangement, and to computer program products.

### BACKGROUND OF THE INVENTION

Embedded systems such as a chip for a mobile radio platform, or in other words for a mobile radio communication device, are confronted ever more frequently with security requirements which are normally satisfied by integrating cryptographic hardware in the components, for example the chips. However, cryptographic hardware may be subject to export control.

### BRIEF DESCRIPTION OF THE FIGURES

Exemplary embodiments of the invention will be explained in more detail in the following text, and are illustrated in the figures, in which:

FIG. 1 shows a sketch of a mobile radio communication terminal according to one exemplary embodiment of the invention;

FIG. 2 shows a block diagram of a circuit arrangement according to one exemplary embodiment of the invention;

FIG. 3 shows a block diagram illustrating the exemplary embodiment of the crypto unit in the circuit arrangement illustrated in FIG. 2;

FIG. 4 shows a flowchart illustrating a method for access monitoring of the crypto unit according to one exemplary embodiment;

FIG. 5 shows a flowchart illustrating the starting up of the circuit arrangement according to one exemplary embodiment of the invention;

FIG. 6 shows a block diagram illustrating the memories for the circuit arrangement according to one exemplary embodiment of the invention;

FIG. 7 shows a flowchart illustrating the method for starting up the circuit arrangement according to one exemplary embodiment of the invention, in detail;

FIG. 8 shows a block diagram illustrating the organization of the data used for cryptographic purposes, according to one exemplary embodiment of the invention;

FIG. 9 shows a block diagram illustrating the chain of trust according to one exemplary embodiment of the invention;

FIG. 10 shows a host computer system according to one exemplary embodiment of the invention;

FIG. 11 shows a block diagram illustrating a method for access monitoring to a CPU according to one exemplary embodiment of the invention; and

FIG. 12 shows a central data processing unit according to another exemplary embodiment of the invention.

Similar or identical elements are provided with identical reference symbols in the figures, while this is worthwhile.

### DETAILED DESCRIPTION

Embedded systems such as a chip for a mobile radio platform, or in other words for a mobile radio communication device, are confronted ever more frequently with security requirements which are normally satisfied by integrating cryptographic hardware in the components, for example the chips.

Cryptographic hardware, that is to say by way of example processors designed specifically for cryptographic functions, or specific electronic circuits, are normally subject to export control and the export regulations of the so-called Wassenaar Arrangement.

The Wassenaar Arrangement relates to technologies which can be used both for military purposes and for commercial purposes, and includes a set of rules with which the participant states comply, or in other words to which the signatory states to the Wassenaar Arrangement are bound. The Wassenaar Arrangement relates, for example, to encryption methods when using a key length of more than 56 bits.

As has been described above, the Arrangement includes a set of rules in accordance with which the export of cryptographic technology is permissible if it used for specific purposes, for example for authentication or for digital rights management (DRM).

One difficulty, for example for manufacturers of mobile radio components or mobile radio platforms, is, for example, that the functionality of the component or components, platform or platforms (for example including applications which use the respective cryptographic technology) cannot be provided in its entirety at the time at which the component or platform is exported.

A mobile radio communication terminal manufacturer normally develops the complete mobile radio platform, or matches at least one supplied mobile radio platform, to his requirements and needs. This means that the cryptographic technology can still be generally used at the time when the component or platform is exported. Since ever more mobile radio communication terminal manufacturers are moving production and development of mobile radio communication devices to countries which have not ratified the Wassenaar Arrangement and are therefore subject to complete export control, the problem of exporting cryptographic technology is becoming of major importance to the mobile radio business. Furthermore, a corresponding problem must be solved for the situation in which complete mobile radio communication devices (for example mobile radio communication terminals) are intended to be delivered from abroad from states which have not ratified the Wassenaar Arrangement.

Cryptographic technology has frequently been used for product export purposes in which cryptographic keys with a length of less than 56 bits have been used, or in other words the key length of the cryptographic keys used for the purposes of the respective cryptographic functions has been reduced so that the cryptographic technologies and the cryptographic functions used are not subject to the export restrictions. However, this will not be an acceptable solution in the future, since the current security standards require a key length of at least 128 bits for symmetrical encryption and 1 Kbit (1024 bits) for asymmetric encryption. However, these key lengths are subject to export restrictions.

Another normal procedure for taking account of the export restrictions is to develop exported software which is designed such that it does not call any cryptographic functions which are not permissible for it in accordance with the export restrictions. However, this does not solve the problem of exporting an entire cryptographic mobile radio platform or individual cryptographic functions in a mobile radio component or in the entire mobile radio platform.

Until now, the complete mobile radio system, that is to say the complete mobile radio communication device, has been exported in which the applications, or in other words the application computer programs that are used, have already been integrated and have been designed such that the legal framework with regard to the key length and/or the respective application has been ensured. However, this procedure will not represent an acceptable solution in the future, since there is a frequent need to move the development and production of mobile radio communication terminals to countries which have not ratified the Wassenaar Arrangement.

According to one embodiment of the invention, a circuit arrangement is provided that has at least one crypto unit which provides at least one cryptographic function. Furthermore, the circuit arrangement has an access monitoring interface for checking an access request from an application computer program to a cryptographic function of the crypto unit, with the access monitoring interface being designed such that
it checks whether the application computer program is authorized to access the cryptographic function of the crypto unit,
if the application computer program is authorized to access the cryptographic function of the crypto unit, the cryptographic function is called, and
if the application computer program is not authorized to access the cryptographic function of the crypto unit, the access request is refused.

A communication device, e.g. a mobile communication device, has a circuit arrangement as described above according to one embodiment of the invention.

According to one exemplary embodiment of the invention, in a method for starting up (booting) a circuit arrangement, a check is carried out to determine whether the user who is starting up the circuit arrangement is authorized to use the at least one cryptographic function provided by the circuit arrangement. If the user is not authorized to use the at least one cryptographic function provided by the circuit arrangement, the circuit arrangement is started up in a first mode, in which the user has no access to the at least one cryptographic function provided by the circuit arrangement. If the user is authorized to use the at least one cryptographic function provided by the circuit arrangement, the circuit arrangement is started up in a second mode, in which the user has access to the at least one cryptographic function provided by the circuit arrangement.

According to one exemplary embodiment of the invention, a method is provided for starting up a circuit arrangement in which a check is carried out to determine whether the user who is starting up the circuit arrangement is authorized to use the at least one function provided by the circuit arrangement. If the user is not authorized to use the at least one function provided by the circuit arrangement, the circuit arrangement is started up in a first mode in which the user has no access to the at least one function provided by the circuit arrangement.

By way of example, in this case, the circuit arrangement may be a graphics accelerator processor or a frequency processor.

One exemplary embodiment of the invention provides that, if the user is authorized to use the at least one function provided by the circuit arrangement, the circuit arrangement is started up in a second mode in which the user has access to the at least one function provided by the circuit arrangement.

Another exemplary embodiment of the invention provides a method for operating a circuit arrangement in which an access request is received from an application computer program to a cryptographic function which is provided by the circuit arrangement. A check is also carried out to determine whether the application computer program is authorized to access the cryptographic function. If the application computer program is authorized to access the cryptographic function, the cryptographic function is called and, if the application computer program is not authorized to access the cryptographic function, the access request is refused.

According to other refinements of the invention, computer program products are provided which, when they are executed by a processor, include the methods described above.

The exemplary embodiments of the invention ensure in a simple manner that an application computer program can use cryptographic functions only if it is authorized to do so, with this illustratively being achieved by means of the access monitoring. The circuit arrangement which is being started up and has been described above ensures that, only in the situation in which an authorized and trustworthy instance has started up the circuit arrangement does this instance also have access during operation of the circuit arrangement to the cryptographic function which is implemented in the circuit arrangement and is therefore intrinsically provided.

According to one exemplary embodiment of the invention, the circuit arrangement has an application processor for executing the application computer program, in general a processor for executing general functions within the circuit arrangement. In one alternative embodiment of the invention, a plurality of processors is provided, and jointly provides the respective function or the respective functions.

According to another refinement of the invention, the circuit arrangement has a first boot memory for storing a first partial boot routine for booting, in other words for starting up the circuit arrangement. The first boot memory may be a read only memory (ROM). Furthermore, at least one cryptographic function which can be used, for example, for the purposes of starting up the circuit arrangement can be stored in the first boot memory in which case, according to one embodiment of the invention, the cryptographic function stored in the boot memory cannot be called from an application computer program, since the cryptographic function is stored in a hard-wired form in the read only memory, in general in the boot memory, which is used exclusively within the process of starting up the circuit arrangement and not during normal operation of the circuit arrangement, during which the application computer programs are executed.

The at least one cryptographic function stored in the boot memory includes, according to one exemplary embodiment of the invention, at least one of the following cryptographic functions:
a symmetrical encryption function,
an asymmetric encryption function,
a hash function.

The cryptographic functions implemented and stored in the first boot memory may be used during the course of startup for cryptographically protected starting up of the circuit arrangement with ensured authentication, thus ensuring, for example, that only a user who has been authenticated using cryptographic security mechanisms is granted access to the (for example powerful) cryptographic functions during operation of the circuit arrangement, and those users who should be granted access to the cryptographic functions are actually determined during the process of starting up the circuit arrangement, using cryptographic services, for example the cryptographic functions, and, although they can operate the circuit arrangement, they can do so, however, only in a mode in which no access is allowed to the cryptographic functions of the crypto unit.

This ensures, even when the circuit arrangement is started up as well as in the course of development of application computer programs in the course of development of the circuit arrangement, that only those users and developers of application computer programs who are authorized, for example, in accordance with the Wassenaar Arrangement to do so can use powerful cryptographic technology.

According to another exemplary embodiment of the invention, a first key memory is provided in the circuit arrangement for storing a first public key of a trustworthy instance, for example by the manufacturers of the circuit arrangement. The first key memory may also be a read only memory.

Furthermore, a customer information memory can be provided for storing customer-specific information, and this may also be a read only memory.

The customer information memory may also be formed from fuse links, for example electronic fuse links, also referred to as electronic fuses.

According to one exemplary embodiment of the invention, at least a part of the customer-specific information indicates whether at least one of the stored keys is a test key or a product key, or in another words whether the key being used can be used only for test operation of the circuit arrangement or for actual operation in the complete commercially available end product. A test key cannot be used during operation of the end product.

Alternatively or additionally, at least some of the customer-specific information may represent information by means of which a customer or a manufacturer of an application computer program is uniquely identified. In this description, the expression “unique” should, for example, be understood as meaning that two customers and/or two manufacturers of an application computer program are not identified by the same information.

Furthermore, at least one second key memory for storing a second public key can be provided in the circuit arrangement.

Furthermore, at least one certificate memory for storing at least a part of a certificate of the second public key or of the entire certificate of the second public key can be provided.

The part of the certificate of the second public key may contain one or more of the following information items:
a statement about the version of the certificate of the second public key;
a statement which identifies a chip which contains at least a part of the circuit arrangement;
customer-specific information;
information which identifies the type of the access monitoring interface.

Furthermore, a first signature memory can be provided for storing a first signature, which is formed using one or more of the following information items:
at least a part of a certificate of the second public key;
the second public key;
a hash value which has been formed using at least a part of a certificate of the second public key;
a hash value which has been formed using the second public key;
a hash value which has been formed using at least a part of the certificate of the second public key, and the second public key.

The first digital signature may be formed using the first private key, which corresponds to the first public key.

Furthermore, the circuit arrangement may have an application computer program memory for storing one or more application computer programs.

Furthermore, a second boot memory may be provided for storing a second partial boot routine for booting the circuit arrangement, wherein the second partial boot routine can be executed after the first partial boot routine has been successfully executed.

The second partial boot routine may include authentication of the one or more application computer programs stored in the application computer program memory.

According to one refinement of the invention, the second partial boot routine may include authentication of a crypto unit application and programming interface computer program.

The crypto unit application and programming interface computer program can be authenticated using a further public key. The further public key may be allocated together with an associated further private key to the manufacturer of the circuit arrangement or to some other trustworthy instance, for example to the developer of the crypto unit application and programming interface computer program, or to a trustworthy instance for the crypto unit application and programming interface computer program.

Furthermore, a second signature memory can be provided for storing a second digital signature, which is formed using one of the following information items:
at least a part of a certificate of the second public key;
the second public key;
the first digital signature;
the second partial boot routine.

Furthermore, the second digital signature may be formed using the second private key, which corresponds to the second public key.

By way of example, the second public key and the second private key may be allocated to a user of the circuit arrangement or to a developer of application computer programs who is certified, for example by the trustworthy instance, for example the manufacturer of the circuit arrangement, for trustworthiness and the authorization to use powerful cryptographic mechanisms, thus ensuring that the holder of the second key pair (comprising the second public key and the corresponding second private key) may use the cryptographic functions of the crypto unit.

The at least one crypto unit may be designed to provide at least one of the following cryptographic functions:
a symmetrical encryption function;
an asymmetric encryption function;
a hash function;
a random number generation function;
an authentication function.

The cryptographic functions provided by the crypto unit are, for example, cryptographic functions from a powerful cryptographic technology so that, within the scope of these functions, it is also possible to provide functions to which the restrictions of the Wassenaar Arrangement apply, while, however, allowing fair export monitoring on the basis of the cryptographically protected starting up procedure and the cryptographically protected access monitoring of cryptographic functions provided by the crypto unit. In this context, for example, the word fair means the capability to be monitored and understood by both parties, that is to say both by the processor system manufacturer, for example the manufacturer of the circuit arrangement, for example Infineon Technologies AG, and the application developer. This therefore means that the cryptographic functions can also be provided using key lengths of 128 bits or even 1024 bits or more, without any problems, in the circuit arrangement.

At least one of the following memories may be a chip-external memory:
the at least one second key memory;
the at least one certificate memory;
the at least one first signature memory;
the application computer program memory;
the second boot memory;
the at least one second signature memory.

A plurality of the following memories, for example all of the following memories, may be provided in a common chip-external memory:
the at least one second key memory;
the at least one certificate memory;
the at least one first signature memory;
the application computer program memory;
the second boot memory;
the at least one second signature memory.

The first partial boot routine can be designed such that, if it fails, the user is not given access to the crypto unit during operation of the circuit arrangement.

Furthermore, the second partial routine may be designed such that, if it fails, the user is not given access to the crypto unit.

The communication device may be a mobile radio communication device.

In the method for starting up (booting) a circuit arrangement, the check as to whether the user who is starting up the circuit arrangement is authorized to use the at least one cryptographic function provided by the circuit arrangement may include a check of a certificate of a public key of the user.

Furthermore, the check may include:
a check of a second public key;
if the second public key is not valid, the circuit arrangement is started up in the first mode, and
if the second public key is valid, the circuit arrangement is started up in the second mode.

Furthermore, the check to determine whether the user who is starting up the circuit arrangement is authorized to use at least one cryptographic function provided by the circuit arrangement may include:
a hash value is formed using at least the second public key,
a stored hash value is read which is formed using at least the second public key,
the hash value that has been formed is compared with the hash value that has been read,
if the two hash values do not match one another, the circuit arrangement is started up in the first operating mode,
if the two hash values match one another, the circuit arrangement is started up in the second mode.

Furthermore, the check to determine whether the user who is starting up the circuit arrangement is authorized to use at least one cryptographic function provided by the circuit arrangement may include:
a second digital signature which is formed using one of the following information items is checked:
at least a part of a certificate of the second public key;
the second public key;
the first digital signature;
the second partial boot routine;
if the second digital signature is not valid, the circuit arrangement is started up in the first mode,
if the second digital signature is valid, the circuit arrangement is started up in the second mode.

According to another exemplary embodiment of the invention, a circuit arrangement is provided which has at least one first computation unit for executing at least one computer program, an access monitoring interface unit for checking an access request to the first computation unit, an input/output interface which is shared by the first computation unit and the access monitoring interface unit, and a computation-unit-external bus which is coupled to the input/output interface. The access monitoring interface unit is coupled to the input/output interface such that the access request is determined by it. Furthermore, the access monitoring interface unit is designed such that it checks whether the access request satisfies a predetermined access criterion, and such that, if the access request satisfies the predetermined access criterion, the first computation unit is allowed to process the access request. If the access request does not satisfy the predetermined access criterion, the access request is refused, or predetermined action is carried out.

According to one refinement of the invention, the access monitoring interface unit is a second computation unit.

Furthermore, the first computation unit may be a programmable processor.

The first computation unit may be contained in a first chip.

According to another refinement of the invention, the access monitoring interface unit is a programmable processor.

Furthermore, the access monitoring interface unit may be contained in a second chip.

The access monitoring interface unit may be provided in a security controller for the second chip.

According to one exemplary embodiment of the invention, the first chip and the second chip are accommodated in a common housing, with the input/output interface being a housing interface.

According to one exemplary embodiment of the invention, the circuit arrangement has a computation-unit-internal bus, with the first computation unit and the access monitoring interface unit being coupled to the computation-unit-internal bus.

The computation-unit-internal bus may be designed in accordance with the JTAG Standard. In general, in one alternative refinement of the invention, any other desired interprocessor bus can be used as the computation-unit-internal bus.

According to another exemplary embodiment of the invention, the circuit arrangement has at least one circuit component, wherein the access monitoring interface unit is designed such that, if the access request does not satisfy the predetermined access criterion, the at least one circuit component is deactivated.

Furthermore, the access monitoring interface unit may be designed such that, if the access request does not satisfy the predetermined access criterion, the functionality of the circuit component is reduced.

According to one exemplary embodiment of the invention, the access monitoring interface unit is designed to carry out at least one cryptographic function.

According to one exemplary embodiment of the invention, the access monitoring interface unit is integrated in the first computation unit.

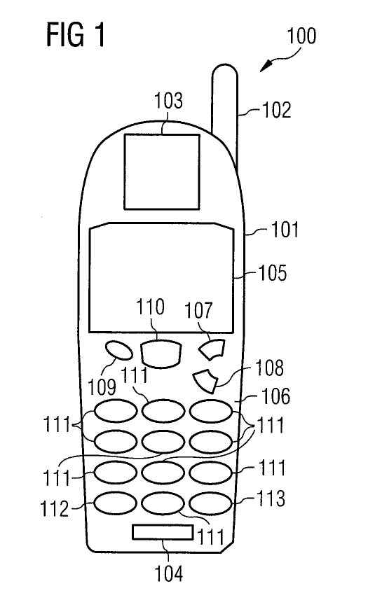

FIG. 1 shows a mobile radio communication terminal 100 according to one exemplary embodiment of the invention.

The mobile radio communication terminal 100 has an antenna 102, which is incorporated in a housing 101 or is fitted to it, as well as a loudspeaker 103 and a microphone 104. Furthermore, the mobile radio communication terminal 100 is provided with a display 105 and a keypad 106 with a multiplicity of keys such as function keys 107, 108, 109, 110, such as a switch-on key 107, a switch-off key 108 and a communication link termination key 109, or a communication link setting-up key 110. Furthermore, a multiplicity of number keys 111 are provided in the keypad 106, and each represent one digit from 0, 1, . . . , 9. Furthermore, two symbol keys are provided, a “#” key 112 and a “*” key 113.

According to this exemplary embodiment of the invention, the mobile radio communication terminal 100 is designed in accordance with a third-generation mobile radio communication standard, for example in accordance with UMTS (Universal Mobile Telecommunications System), alternatively in accordance with GPRS (General Packet Radio Service), EDGE (Enhanced Data Rates for GSM Evolution), CDMA 2000 (Code Division Multiple Access 2000) or FOMA (Freedom of Mobile Multimedia Access).

Alternatively, the mobile radio communication terminal 100 may be designed in accordance with a second-generation mobile radio communication standard, for example in accordance with GSM (Global System for Mobile Communications). Furthermore, the mobile radio communication terminal 100 may be designed in accordance with a communication standard for a subsequent mobile radio generation.

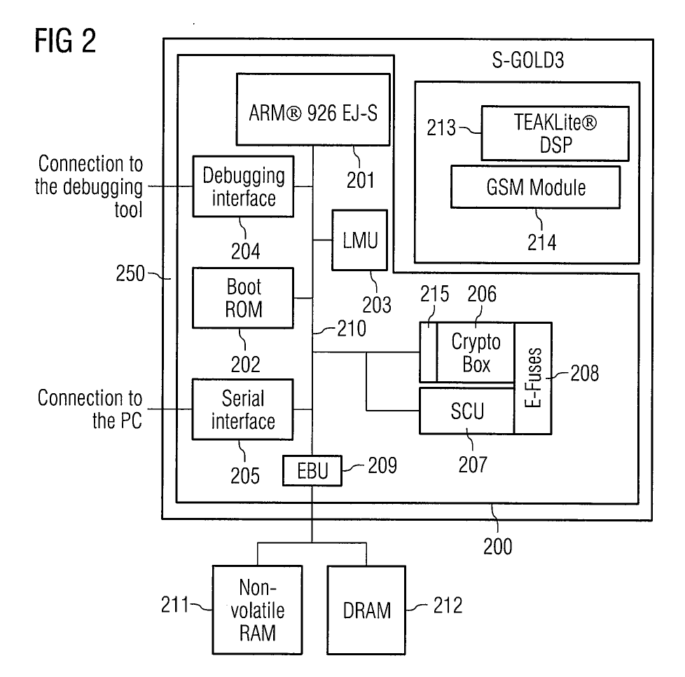

Furthermore, the mobile radio communication terminal has the normal electronic components for mobile radio communication purposes, such as a communication processor chip 200, also referred to in the following text as a mobile radio processor chip 200, as is illustrated in detail, by way of example, in FIG. 2.

A communication chip system 250 as illustrated in FIG. 2 has the mobile radio processor chip 200, according to this exemplary embodiment of the invention an S-Gold3™-Chip from the company Infineon Technologies AG, which is a baseband controller for use in the GSM/UMTS mobile radio communication terminal 100, as is provided according to the exemplary embodiment of the invention. The mobile radio processor chip 200 is the central controller within the mobile radio communication terminal 100 and contains the essential intelligence for the mobile radio communication terminal 100. Since the number of security-relevant applications such as digital rights management (DRM) applications and other mobile commercial application computer programs which are installed in the mobile radio communication terminal 100 is rising evermore, the need for improved security is also increasing.

FIG. 2 shows the structure of the mobile radio controller 200 in detail. The mobile radio controller 200 has an ARM 926 EJ-S processor 201, which represents the central microprocessor in the mobile radio controller 200.

Furthermore, a start-up read only memory 202 (boot read only memory, Boot ROM) is provided, in which at least one first partial boot routine is stored, in other words a partial routine for starting up the mobile radio communication terminal 100 and the processor 201. In addition to the read only memory for the first partial boot routine 202, a volatile local memory 203 is provided, although this is kept relatively small for cost reasons. The volatile on-chip memory 203 is also referred to in the following text as a local memory unit (LMU) 203. Furthermore, a debugging interface 204 is provided, by means of which a debugging tool can be connected to the mobile radio controller 201.

By way of example, the processor 201 may be connected to a personal computer or to a workstation by means of a serial interface 205 that is likewise provided. Furthermore, a crypto unit 206, also referred to in the following text as a crypto box, as well as a system control unit 207 are provided, together with electronic fuse links 208, which will be explained in more detail in the following text. In addition, the processor chip 200 has an external bus interface 209. The processor 201, the boot ROM 202, the volatile local memory unit 203, the debugging interface 204, the serial interface 205, the crypto unit 206 and the system control unit 207 as well as the external bus interface 209 are coupled to one another by means of a chip-internal data and an address bus 210.

The processor chip 200 is connected by means of the external bus interface 209 to a non-volatile random access memory (non-volatile random access memory, non-volatile RAM) 211 and to a volatile random access memory 212, for example to a dynamic random access memory (dynamic random access memory, DRAM).

Furthermore, another digital signal processor 213, for example a TEAKLite digital signal processor (DSP) can also be provided in the communication chip system 250, as well as mobile radio communication modules 214, for example a GSM communication module and/or a UMTS communication module, which provide the functions of the physical interface for the respective mobile radio communication standards.

Once the processor 201 has been started up using the boot routine which is stored in the boot ROM 202, computer programs are executed, in other words a computer program code which is stored in the non-volatile random access memory 211.

As has been described above, the processor 201 uses the chip-internal bus 210 and the external bus interface 209 to access the non-volatile random access memory 211. The processor 201 also uses the chip-internal bus 110 and the external bus interface 209 to access the volatile random access memory 212.

In this context, it should be noted that, in one alternative embodiment of the invention, the non-volatile random access memory 211 together with, as an alternative or in addition, the volatile random access memory 212 can also be integrated in the processor chip 200.

These exemplary embodiments of the invention use the electronic fuse links 208 (electronic fuses, also referred to in the following text as E-fuses) to store unique customer-specific information on the processor chip 200. Each electronic fuse link 208 represents a single bit of information which can be set to a value which corresponds to the desired information, once the processor chip 200 has been completely manufactured.

A tool provided specifically for this purpose is normally used to set the values of the electronic fuse links 208, for example in order to burn through the respectively desired electronic fuse link 208. This can be done, for example, by the chip manufacturer or else by the mobile radio communication terminal manufacturer for whom the chip manufacturer, in other words the manufacturer of the processor chip 200, is the supplier. Once an electronic fuse link 208 has been burnt through, then it is no longer possible to change the value of this fuse link.

The electronic fuse links 208 are used both for storage of information which is used by the crypto unit 206 and for storage of information which is used by the system control unit 207.

The system control unit 207 is a central unit which contains logic elements for controlling the functionality of various units in the communication processor system 250.

The electronic fuse links 208 are used in order to match the processor system 250 to customer requirements, to be precise in a non-volatile and secure manner, such that these customer-specific processor systems 250 can be used flexibly in the mobile radio communication terminal 100. For example, a unique fuse link identification tag (also referred to as a fuse link ID) is stored in the electronic fuse links 208 and uniquely identifies each S-Gold3 processor system 250. This fuse link identification tag is, according to this exemplary embodiment of the invention, burnt in at the factory by the chip manufacturer, for example by Infineon Technologies AG.

The serial interface 205 can be used for loading computer programs in the mobile radio communication terminal, to be more precise in the processor chip 200.

The loading and, if required, the execution of the loaded computer programs as well are controlled and monitored on-chip by means of on-chip security architecture, provided by means of the crypto unit 206, for example. Details relating to this will be explained in more detail in the following text.

In addition, the debugging interface 204 allows access to the non-volatile random access memory 211, in other words with the debugging interface 204 representing a second interface which has access rights to the non-volatile random access memory 211, as will likewise be explained in more detail in the following text.

The security architecture, as described in the following text, of the S-Gold3 processor system 250 is, according to one exemplary embodiment of the invention, based on secure booting, during the course of which powerful cryptography is used. This ensures that, once the S-Gold3 processor system 250 has been started up, the set of computer program codes used and which is executed originates from a trustworthy legitimated source, has not been modified without authorization and was and also is intended to be executed by the respective specific S-Gold3 processor system 250, identified for example by means of the fuse link identification tag.

In fact, for example, the processor 201 may be regarded as a trustworthy processor core on which the only computer program code that is executed is that which has been certified by the mobile radio communication terminal manufacturer. Application computer programs which are loaded by the user of the communication terminal 100 must be certified. The S-Gold3 secure booting loader, which will be explained in more detail in the following text, makes it possible for the mobile radio communication terminal manufacturer to ensure that the program memory can be written to only by authorized computer programs, or in other words it can be updated only by such authorized computer programs, and that the source and the legitimation of each application computer program that has been loaded or is to be loaded can be checked.

The S-Gold3 processor system 250 has a cryptographic block, as has been described above, also referred to as a crypto unit 206, which makes it possible to produce secure systems. The S-Gold3 processor system 250 and the associated framework which will be described in the following text make it possible for a mobile radio communication terminal manufacturer to produce and to design a mobile radio communication terminal 100 with a processor system 250, which simplifies controlled export subject to the dual-use export regulations.

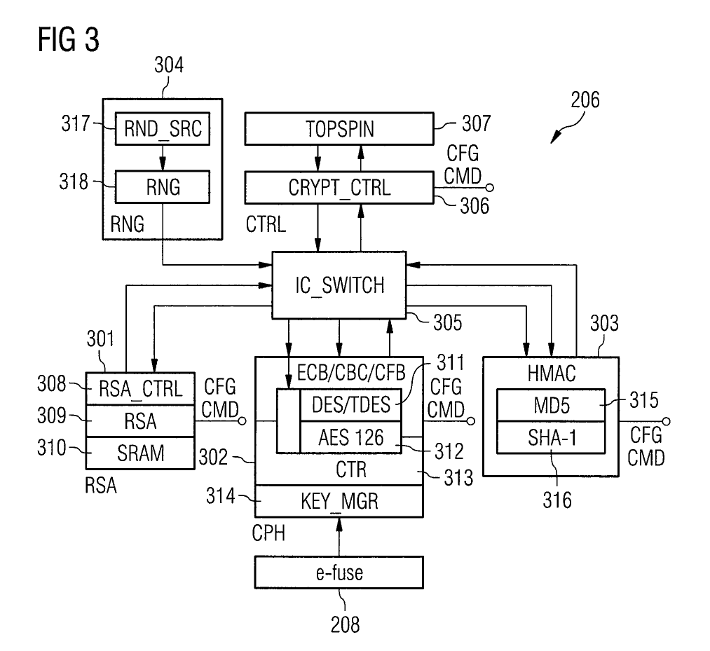

FIG. 3 shows the structure and configuration of the crypto unit 206 in detail.

The following hardware acceleration components are provided in the crypto unit 206 in order to provide the following cryptographic security services:
an asymmetrical encryption/decryption unit 301,
a symmetrical encryption/decryption unit 302,
a single-use hash function unit 303, and
a random number generation unit 304.

Furthermore, the crypto unit 206 has a security service selection unit 305 and a crypto unit control unit 306, as well a chip-internal bus interface 307.

The interface 307 provides an interface to the chip-internal address and databus 210, and thus the communication link to the processor 201.

The asymmetric encryption/decryption unit 301 has at least one hardware accelerator in order to provide an asymmetric encryption method and/or decryption method, according to this exemplary embodiment of the invention, a hardware accelerator in order to provide the RSA method. Furthermore, the asymmetric encryption/decryption unit 301 according to this exemplary embodiment of the invention has an RSA control unit 308 for controlling the RSA method which is provided by means of the RSA hardware accelerator 309.

Furthermore, a static random access memory (SRAM) 310 is provided in the asymmetric encryption/decryption unit 301.

The symmetrical encryption/decryption unit 302 has one or more symmetrical encryption hardware accelerators in order to provide one or more symmetrical encryption methods, for example in order to provide the data encryption standard method (DES), the triple data encryption standard method (TDES), the international data encryption algorithm method (IDEA) or else the advanced encryption standard method (AES), in general any symmetrical encryption method and/or decryption method provided that is, for example, current-cipher or block-cypher based.

According to this exemplary embodiment of the invention, the symmetrical encryption/decryption unit 302 has a DES/TDES hardware accelerator 311 and an AES hardware accelerator 312, which is designed to encrypt/decrypt data by means of a key with a length of 128 bits. Furthermore, a corresponding control unit 313 is provided, and a key management unit 314. The symmetrical encryption/decryption unit 302 is coupled by means of a fuse link interface (not shown) to the respective electronic fuse links 208, which are used for the purpose of symmetrical encryption and decryption of data.

The single-use hash function unit 303 is designed to provide a single-use hash function, which is applied to the data supplied to this unit, with the respective hash value determined using the data supplied to the unit being provided, in accordance with the respective single-use hash function, on the output side of the single-use hash function unit 303.

According to this exemplary embodiment of the invention, the following single-use hash function hardware acceleration units are provided:
an MD5 hardware accelerator unit 315 and
a secure hash algorithm 1 (SHA-1) hardware accelerator unit 316.

The random number generation unit 304 has a random number source 317 and a random number generation algorithm hardware acceleration component 318, which generates a random number using the information provided by the random number source 317.

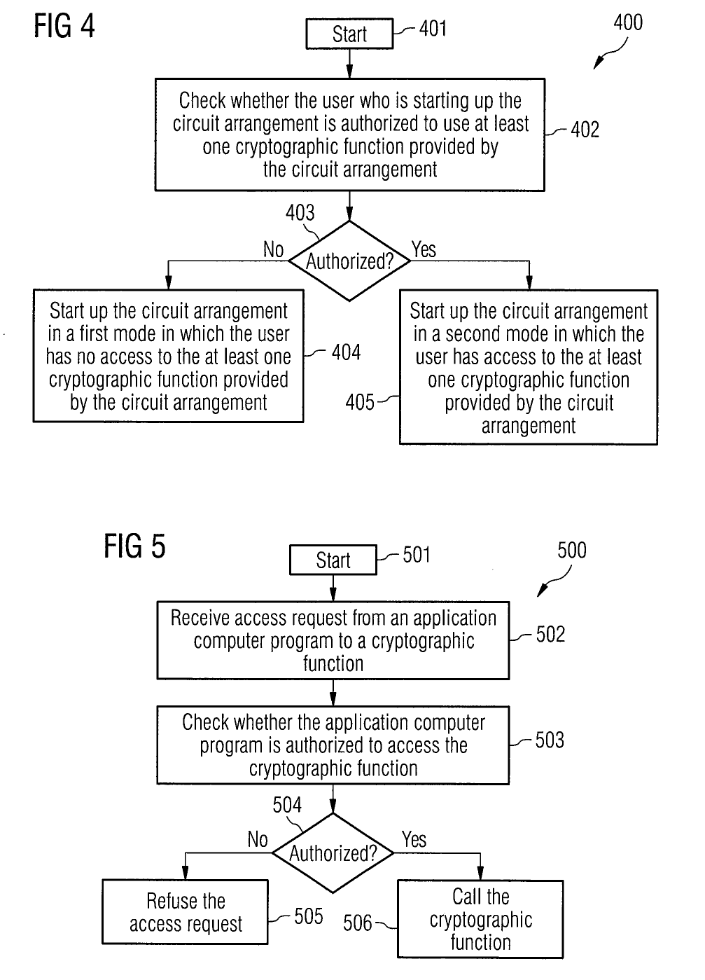

FIG. 4 uses a flowchart 400 to illustrate a method for starting up the processor system 250 according to one exemplary embodiment of the invention.

Once the starting-up process has been commenced (step 401), a check is carried out to determine whether the user who is starting up the processor system 250 is authorized to use at least one cryptographic function provided by the processor system 250 (step 402). If the user is not authorized to use at least one cryptographic function provided by the processor unit 250, to be more precise by the crypto unit 206 (“no” in test step 403), then the processor system 250, to be more precise the processor 201, is started up in a first operating mode in which the user has no access to the at least one cryptographic function provided by the crypto unit, in general by the circuit arrangement. However, if the user is authorized to use at least one cryptographic function provided by the circuit arrangement, for example by the crypto unit 206 (“yes” in test step 403), then the circuit arrangement, for example the processor 201, is started up in a second operating mode in which the user has access to the at least one cryptographic function provided by the circuit arrangement, for example by the crypto unit 206.

The flowchart 500 in FIG. 5 illustrates the execution of an application computer program, for example the processing of an access request from an application computer program being executed, to a cryptographic function provided by the processor system 250, in general to a cryptographic function provided by the circuit arrangement.

After starting the application computer program which, for example, is stored in the non-volatile random access memory 211 and in the volatile random access memory 312 (step 501), an access request may be received from the application computer program with the aid of which access can be made to a cryptographic function provided by the circuit arrangement, for example by the crypto unit 206 (step 502). Once an access request such as this has been received, the processor 201, for example, checks whether the application computer program is authorized to access the desired cryptographic function, in general the unit which provides the at least one cryptographic function, for example the crypto unit 206 (step 503).

If the application computer program is not authorized to access the cryptographic function (“no” in test step 504), then the access request is refused (step 505). However, if the application computer program is authorized to access the cryptographic function (“yes” in test step 504), then the respective desired cryptographic function is called (step 506).

According to the exemplary embodiments of the invention, a framework is provided by means of which it is possible to restrict the use of the cryptographic functions of the crypto unit in the processor system 250 to only those mobile radio communication terminal manufacturers who have agreed to comply with a set of rules which ensure that the end product, that is to say for example the mobile radio communication terminal 100, complies with the “dual-use” export regulations, for example in the Wassenaar Arrangement.

According to these exemplary embodiments of the invention, a cryptographic certificate of the processor system manufacturer, for example a cryptographic certificate of Infineon Technologies AG is used as the basis (also referred to as the root) of the monitoring framework, and is stored in the boot ROM 202.

Every customer to whom the processor system 250, for example the S-Gold3 processor system 250, is delivered, likewise has a root certificate which is stored in the non-volatile random access memory 211, with the root certificate having been digitally signed by a trustworthy instance, for example by the processor system manufacturer, in a digital form using his private cryptographic key. The root certificate of the customer represents the agreement to the respective export arrangements, and the program procedure when carrying out the boot program stored in the boot ROM 202 is carried out appropriately.

These exemplary embodiments of the invention provide the following options:

The mobile radio communication terminal manufacturing company exports software, that is to say application computer programs, which comply with the “dual-use” export regulations. In this case, it is necessary for the mobile radio communication terminal manufacturer to apply for an export license to use its respective software, that is to say the corresponding application computer program, within the processor system 250, for example within the S-Gold3 processor system.

The processor system manufacturer, for example Infineon Technologies AG, supplies appropriate crypto unit application and programming interface software (also referred to in the following text as Crypto Box Application and Programming Interface, CAPI). The CAPI controls the use of the crypto unit 206, as well as the access to the crypto unit 206.

In case 2, the mobile radio communication terminal manufacturer must draw the following distinction:
the mobile radio communication terminal manufacturer agrees to develop and to use software, that is to say application computer programs, which call a supplied authentication routine (for example supplied from the processor system manufacturer, for example by Infineon Technologies AG, in general by a trustworthy instance), by means of which the CAPI is checked, or
the code stored in the boot ROM 202 calls the authentication routine when the processor 201 is being started up.

In the following text, the root certificate of the mobile radio communication manufacturer is referred to as the GOLD public key (GPuK) since this represents the public key which links the content of the non-volatile program memory 211 to the processor system components.

The processor system components in the processor system 250 which are exported subject to control are “fused” in such a way that the crypto unit 206 is not accessible, in other words in such a way that it is not possible to access the crypto unit 206 and the cryptographic function provided by it. The crypto unit 206 can be made accessible only by means of an additional extra fuse operation.

This fuse operation leads to the processor system 250, for example S-Gold3, being started up only using the Infineon root certificate, which is stored in the boot ROM 202. This means that the only customer, in other words user, who has access to the crypto unit hardware is one who starts up the system with a valid signed certificate, which is stored in the non-volatile random access memory 211.

According to one exemplary embodiment, the crypto unit 205 can be accessed only by means of a crypto application and program interface (CAPI) 215. The crypto functionality which is provided by the crypto unit 206 and described above cannot be accessed directly from an application, or in other words from an application computer program. Application computer programs access the general purpose interface, and use this to access a crypto unit software driver by means of a trust module. The trust module checks whether the application computer program contains a valid certificate which allows that application computer program complete use of the cryptographic functions and/or cryptographic services provided by the crypto unit 206. Complete use of the functions of the crypto unit 206 includes the use of asymmetric operations with key lengths for the keys that are used of more than 512 bits or, for example, symmetrical encryption operations using keys with a key length of more than 56 bits.

When an application computer program wishes to use a function of the crypto unit 206 for the first time and therefore makes an access request to the crypto unit 206, then it is envisaged that the application computer program will request the trust module to import the cryptographic certificate of the application computer program. The trust module checks the validity of the certificate for the application computer program. Certificates such as these may be allocated only to application computer programs and their manufacturers or developers who act within the export regulations which are defined on the basis of the “dual-use” export regulations and only these application computer programs may be granted access to the full functionality of the crypto unit 206. The mobile radio communication terminal manufacturer digitally signs these cryptographic certificates, which are also referred to in the following text as Secure Application Certificates (SecAppCer) with a private key, allocated the CAPI, of the mobile radio communication terminal manufacturer (also referred to in the following text as the equipment manufacturer, EM) to whom the CAPI is allocated for this respective model of the mobile radio communication terminal 100. This private key is also referred to in the following text as the EMCAPIPrK, and is not stored in the mobile radio communication terminal 100. The public key EMCAPIPuK associated with this private key EMCAPIPrK is stored in the mobile radio communication terminal 100 in order to verify the SecAppCerts. The private key EMCAPIPrK and the associated public key EMCAPIPuK form a common asymmetric key pair.

As will be explained in more detail in the following text, the public key EMCAPIPuK is checked for its validity while the processor system 250 is being started up. The boot routine, which is stored in the boot ROM 202, is designed in a corresponding manner. The public key EMCAPIPuK is the customer-specific public key of the mobile radio communication terminal manufacturer, also referred to in the following text as the GPuK, or alternatively it is a key which is located in a trustworthy chain, protected by a digital signature using the private key of the mobile radio communication terminal manufacturer which, together with the public key of the mobile radio communication terminal manufacturer GPuK, forms an asymmetric key pair, or is protected by means of the public key of the mobile radio communication terminal manufacturer (GPuK).

If cryptographic certificate of an application computer program is imported by the trust module, then this is done in response to the reception of a call from the interface by means of an application computer program call “Import Certificates ( )”. For the purposes of this call, the application computer program transfers an X.509v3 certificate (for example the SecAppCert) to the trust module, with the SecAppCert certificate having been signed using the private, or in other words the secret key, of the mobile radio communication terminal manufacturer EMCAPIPrK. From the call, the trust module determines the certificate and verifies the signature of the public key using the public key, stored in the boot ROM 202, of the mobile radio communication terminal manufacturer EMCAPIPuK.

If the checked certificate to be verified is valid, then the certificate is stored in the non-volatile random access memory 211 of the mobile radio communication terminal 100 together with this associated metadata, which is produced by the trust module, and an appropriate handler routine is passed back to the application computer program. The handler routine can be used by the application computer program for all future operations in which the specific certificate is contained or required.

If the certificate is not valid, then a corresponding error message is returned to the application computer program, or in other words is transmitted to it.

The driver for the crypto unit 216 and the trust module are authenticated, in order to ensure their integrity, while the processor system 250 is being started up. This is done using a certificate which is either stored in the boot ROM 202, or using a certificate which is stored in the non-volatile random access memory 211 and which has already been authenticated using a certificate stored in the boot ROM 202 during startup.

The mobile radio communication terminal 100 uses the crypto unit driver and the trust module, or an identical map of these modules, for each subsequent access or for each access request to the cryptographic functions of the crypto unit 206.

The secure start-up process for the processor system 250 described in the following text is based, according to one exemplary embodiment of the invention, on the principle that a public key which is stored in the program memory, or in other words in the non-volatile random access memory 211, is linked to the processor system 250, for example to the S-Gold3 processor system. This public key, for example the public key GPuK of the mobile radio communication terminal manufacturer is, according to one exemplary embodiment of the invention, stored in an area of the non-mobile, non-volatile random access memory 211, which is also referred to as a Primary Signed Image (PSI), and is located in the block “0” of the program memory 211.

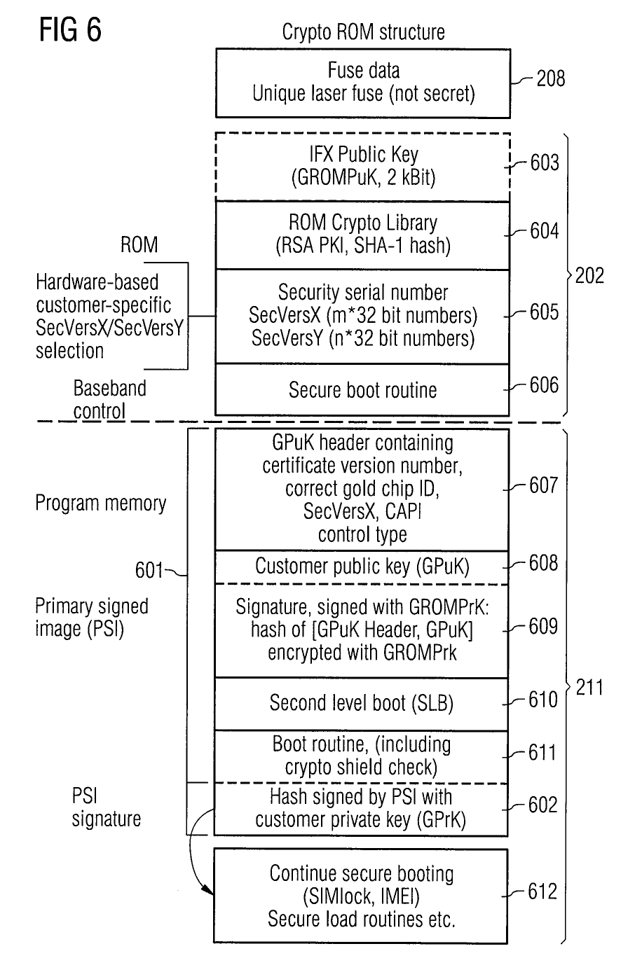

The public key GPuK of the mobile radio communication terminal manufacturer is used by the boot ROM code to check the content of the block “0” of the PSI to determine whether the content is correct and has not been manipulated. The PSI area 601 of the non-volatile random access memory 211 (see FIG. 6) contains a hash value (according to this exemplary embodiment, formed using the SHA-1 method), which has been formed using the remaining area of the PSI area 601. The hash value is signed digitally, in accordance with the RSA method, using the private key GPrK which corresponds to the public key GPuK of the mobile radio communication terminal manufacturer. The digitally signed hash value 602 can be used to check the integrity of the entire boot block, or in other words the entire PSI area 601.

The general method for checking the PSI area 601 is also used by the secure flash loader which is stored in the boot ROM 202. The secure flash loader controls the updating of the non-volatile random access memory 211, also referred to in the following text as a flash memory. The new code, or in other words the new computer program, is loaded in the local memory unit 203 of the S-Gold3 processor system 250 by means of the serial interface 205, for example a USB interface or a UART interface. The flash loader checks the validity of the down-loaded computer program which is stored in the local memory unit 203. If the down-loaded application computer program, in other words the down-loaded computer program code, does not have a correct origin, that is to say it does not originate from a certified manufacturer or developer, or if the down-loaded computer program code has been manipulated without authorization, then the application computer program which is stored in the local memory unit 203 is not executed. In this case, the application computer program which has been temporarily stored in the local memory unit 203 is not written to the non-volatile random access memory 211, or in other words, in this case, the non-volatile random access memory 211 is not updated.

According to this exemplary embodiment of the invention, the security procedure using the processor system 250 is set using the electronic fuse links 208. Two electronic fuse links 208 are provided and allow a non-secure procedure to be set, or a secure procedure.

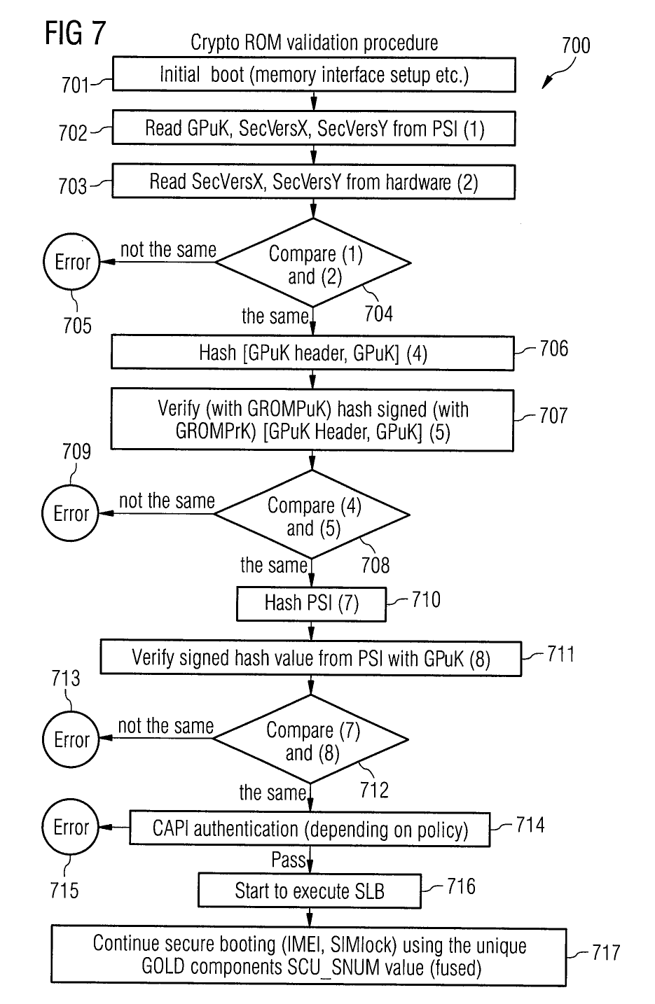

The security-relevant memory structure is illustrated in FIG. 6. The cryptographic validation procedure is illustrated in a flowchart 700 in FIG. 7.

According to these exemplary embodiments of the invention, a cryptographic check of the block “0” (that is to say of the first block of the computer program code in the non-volatile random access memory 211) is always carried out in accordance with the secure starting-up process for the processor system 250, before the computer program code, which is stored in the non-volatile random access memory 211, is executed. The aim in this case is to check the source of the computer program code stored in the non-volatile random access memory 211, and to ensure that it has not illegally been modified since the application computer program was originally stored in the non-volatile random access memory 211. This is done using the cryptographic technologies and methods which will be explained in more detail in the following text.

As is illustrated in FIG. 6, the following information, inter alia, is stored in the boot ROM 202:
the public key of the processor system manufacturer, for example the public key 603 of Infineon Technologies AG, referred to in the following text as GROMPuK 603
a ROM-crypto library 604, in which an RSA method and an SHA-1 single-use hash function method are stored; in addition, hardware-based customer-specific information 605 is stored, for example in the form of security serial numbers, also referred to in the following text as SecVersX (for example m*32 bit numbers), and SecVersY (for example n*32 bit numbers).

Furthermore, the secure boot routine 606 is stored in the boot ROM 202.

The following data is stored in the PSI 601 of the non-volatile random access memory 211:
a header 607 of the public key GPuK of the customer, with the header containing a version number of the certificate as well as the correct identification tag for the processor chip 200, and the security serial number SecVersX and the monitoring type of CAPI;
the public key GPuK 608 of the customer;
a digital signature value 609, signed using the secret key GROMPrK of the chip manufacturer, of the hash value, which was formed using the header 607 of the public key GPuK of the customer and the public key GPuK of the customer, with the hash value being encrypted using the private key GROMPrK of the chip manufacturer;
a second level boot routine 610;
an additional boot routine 611 which, inter alia, contains a check by the crypto unit 206;
as well as the hash value 602, which has been formed using the PSI area 601, using the private customer key GPrK.

Furthermore, further boot sequences are stored in the non-volatile random access memory 611, as well as routines for secure down-loading of data (illustrated symbolically in FIG. 6 by means of a block 612).

A number of cryptographic functions and their principles will be explained in the following text within the context of the exemplary embodiments of the invention.

First of all, a cryptographic single-use hash function will be described. A cryptographic hash function is a cryptographic single-use function which makes it possible to produce a fingerprint of a data piece. Once the computer program code which is stored in the block “0” of the PSI area 601 of the non-volatile random access memory 211 has been generated, the hash value of the stored computer program code is generated, and is stored in the block “0” of the non-volatile random access memory 611. According to this exemplary embodiment of the invention, the hash algorithm SHA-1 is used to generate the fingerprint. SHA-1 is a conventional algorithm which, however, is not sufficient in its own right to ensure the desired level of security. The desired level of security is achieved by digitally signing the hash value that is produced, using a RSA-private key.

This concept will be explained in more detail in the following text.

As has been described above, the block “0” of the non-volatile random access memory 211 contains the public key of the customer, also referred to in the following text as the Gold Public Key GPuK. The GPuK is used to couple the block “0” of the non-volatile random access memory 211 to the processor chip 200, for example to the S-Gold chip. The public key GPuK belongs to an asymmetric key pair. The corresponding associated private, or in other words secret, key in this key pair is also referred to in the following text as the Gold Private Key GPrK. The public key GPuK and the private key GPrK together form an asymmetric customer key pair.

Asymmetric key pairs have the following characteristic: if a piece of data is encrypted using a key in the key pair, then it can be decrypted only using the other key in the same key pair. This means that, in the situation in which one key is a secret key (in this case GPrK), then this secret key can be used to “sign” a piece of data and the associated public key (in this case GPuK) can be used to decrypt the piece of data and thus to verify the origin of the piece of data. GPrK is used to sign the hash value of the block “0” of the non-volatile random access memory 211, and the public key GPuK is used to decrypt the “signed” hash value of the block “0” of the non-volatile random access memory 211 when the processor system 250 is being started up.

The signing process takes place in a secure environment during the production of the platform and of the processor system 250. Furthermore, the private key GPrK is not available in the mobile radio communication terminal platform.

The boot memory 202 contains a boot computer program code which, in this embodiment, has the following routines:

Form a hash value of the block “0” of the non-volatile random access memory 211;

Decrypt (or verify) the stored signed hash value in the block “0” using the public key GPuK;

Check whether the two results match one another.

As has been described above, the routines for carrying out the SHA-1 method and the RSA verification routine are stored in the crypto library 604 as part of the boot ROM computer program code in the ROM memory 202.

The secure boot process, as has been described above, operates when a mechanism for linking the public key GPuK 608 to the customer, which is stored in the non-volatile random access memory 211, is available to the processor chip 200, for example the Gold chip 200.

The concept of linking the public key GPuK 608 of the customer to the processor chip 200 will be explained in more detail in the following text.

As has been described above, the public key GPuK 608 is stored in the block “0” of the non-volatile random access memory 211, although it is stored as part of a cryptographic certificate. This cryptographic certificate is also stored together with a digitally signed hash value of the certificate 609. The hash value is signed using an asymmetric private key, also referred to as GROMPrK. The associated public key GROMPuK is stored in the boot ROM memory 202.

Before the public key GPuK 608 is used, its certificate is hashed by means of the boot ROM computer program code, that is to say a hash value is formed using this. Furthermore, the signed hash value which has been formed using the GPuK certificate is verified using the boot ROM computer program code. The two results are compared with one another. This ensures that the GPuK certificate has not been changed, and originates from a legal source. This results in the public key GPuK being linked to the processor chip 200. The private key GROMPrK is stored in a trust center for secure signing. In this exemplary embodiment, but without any restriction to generality, it is assumed that the chip manufacturer provides a secure environment and defines a process in order to carry out the operations required by the trust center.

The GPuK certificate contains additional information in its header, in order to further improve the security. The header contains some general information item, such as the key length and the exponent, with this general information being RSA-specific.

Furthermore, the GPuK certificate contains the processor chip identification tag, in order to prevent a public key which is used by a baseband controller in a controller family (for example a gold family) being used on a different baseband controller in the same controller family.

The boot ROM computer program code is used to check whether the identification tag which is contained in the GPuK certificate matches the value which is stored in the processor chip 200. Since the GPuK certificate is digitally signed and is therefore linked to this specific processor chip series, for example to this specific GOLD series, the chip ID value contained in the header of the GPuK certificate cannot be illegally changed.

SecVersX is a value which can be selected from four values which are stored in the ROM 202. The actually selected value is governed by the setting of two electronic fuse link bits from the electronic fuse links 208. The SecVersX value stored in the ROM memory 202 is selected by means of the boot ROM computer program code using the set values of the two fuse link bits, and is then compared with the value stored in the GPuK certificate. The main function of the SecVersX is to distinguish between a prototype/test mode and a production mode, and therefore between a prototype/test key and the GPuK key. Test keys do not operate in the completed processor chips 200 which are delivered to the mobile radio communication terminal manufacturer, since different fuse link settings are used for the prototype/test mode and the product mode.

SecVerSY is likewise a value which is selected from a plurality of predefined values stored in the ROM memory 202, and is the same value for all processor chips of the same type, for example for all S-Gold3 chips. The actually selected value is governed by the electrical fuse link settings selected by the customer and which are provided for this purpose. The boot ROM computer program code uses the customer-specific fuse selection setting to select the SecVersY value stored in the ROM memory 202, and compares with this with the value contained in the GPuK certificate. One main function of the SecVersY server is to make it possible to distinguish between different customers. Each customer is allocated a different SecVersY number. Each of the respective mobile radio communication terminal manufacturers must select the SecVersY number allocated to him, with this corresponding to the associated fuse option in the processor chip 200. The fuse link setting must match the SecVersY value in the GPuK certificate. This is checked by means of the boot ROM computer program code.

The public key GPuK of a mobile radio communication terminal manufacturer A does not operate in a mobile radio communication terminal from a different mobile radio communication terminal manufacturer B, since the fuse link settings would be incorrect. Furthermore, the mobile radio communication terminal manufacturer B cannot use the certificate of the mobile radio communication terminal manufacturer A since the latter does not have the corresponding private key.

A customer whose public key GPuK has been compromised cannot just select a new SecVersY number without this being agreed with the trust center, since the trust center has to digitally sign every new certificate

The signing process for the public key GPuK, which takes place in the trust center, ensures that the correct chip identification tag, the correct SecVersX number and the correct SecVersY number are contained in the certificate, before the trust center digitally signs the certificate with the private key GROMPrK. A check is furthermore carried out during the signing process to determine whether the certificate contains the approved monitoring type CAPI for the respective customer.

FIG. 7 shows a flowchart 700 of the method steps for securely starting up the processor system 250, according to one exemplary embodiment of the invention, in detail.

After an initial boot process (step 701), in which the, for example external, bus interface has been initialized with respect to the non-volatile random access memory 211 and the volatile random access memory 212, the GPuK certificate is read, in a next step 702, from the non-volatile random access memory 211, with the GPuK certificate containing the following details, according to one exemplary embodiment of the invention:
the processor chip identification tag (for example the GOLD-chip ID value),
a SecVersX number,
a SecVersY number,
the public key GPuK.

After or before one of the steps 702 or 701, the chip identification tag stored in the system control unit 207 is read from the latter, to be more precise from a register in the system control unit 207. Furthermore, the selected SecVersX number is read from the boot ROM memory 202. The selected SecVersX number to be read is selected on the basis of the setting of the electronic fuse links 208, which is stored in an additional register in the system control unit 207 (step 703).

Furthermore, the SecVersY number is read from the boot ROM memory 202. The SecVersY number to be read is determined using the values of the customer-specific electronic fuse links 208.

A check is carried out in a test step 704 to determine whether the SecVersX number and SecVersY number read in step 702 and determined from the GPuK certificate match the corresponding numbers which are stored in the boot ROM 202. If this is not the case (“no” in test step 704), the boot routine is terminated, and an error message is emitted (step 705).

However, if the two values are the same (“yes” in test step 704), then a hash value is formed in a step 706 using the hash method SHA-1, using the header of the public key GPuK and the public GPuK. The signed hash value 609, which is stored in the non-volatile random access memory 211 and is allocated to the GPuK certificate, is then read, and is decrypted and verified (step 707) using the public key GROMPuK stored in the boot ROM memory 202.

The hash value formed in step 706 and the hash value decrypted in step 707 are compared with one another in a second test step (step 708) and, if the two values do not match one another (“no” in step 708), the boot routine is terminated and an error message is generated and emitted (step 709).

However, if the two hash values match one another (“yes” in step 708), then a second hash value is formed, with the second hash value being formed using the entire content of the block “0” of the non-volatile random access memory 211, and therefore using the content of the PSI area 601 (step 710).

Furthermore, the signed hash values 602, stored in the non-volatile random access memory 211, for the PSI area 601 is read, and is decrypted and verified (step 711) using the previously verified public key GPuK.

In a third test step 712, the two hash values for the PSI area 601 are compared with one another and, if they do not match one another (“no” in the third test step 712), the boot routine is terminated, and an error message is produced and emitted (step 713).

If the two hash values for the PSI area 601 match one another (“yes” in the third test step 712), a CAPI authentication process is carried out (step 714), depending on the respective security policy.

If the CAPI authentication fails, then the boot routine is terminated, and an error message is generated and emitted (step 715). If the CAPI authentication process is successful, the second-level boot routine 610 is read from the non-volatile random access memory 611, and is started (step 716). The second-level boot routine is executed in a step 717, for example using the IMEI (International Mobile Equipment Identity) data stored in the mobile radio communication terminal 100.

It should be noted that the mobile radio communication terminal manufacturer must ensure that his root certificate, which has been allocated to him cannot be changed without authorization (for example using the public key GPuK or a key derived from it). He is likewise responsible for developing a platform whose functionality complies with the “dual-use” export rules.

One exemplary embodiment of the invention provides for the CAPI to be produced by the chip manufacturer, for example by Infineon Technologies AG. In addition, according to one exemplary embodiment, the CAPI authentication routine is also produced by the chip manufacturer. It is necessary to ensure that the mobile radio communication terminal manufacturer calls the CAPI authentication routine during the secure boot process. The CAPI authentication routine contains the public key of the chip manufacturer (that is to say, for example, Infineon Technologies AG), in order to authenticate the CAPI. According to this exemplary embodiment of the invention, the CAPI authentication routine therefore includes the public key IFXCAPIPuK.

One exemplary embodiment of the invention also provides for the trust module and the driver computer programs for the crypto unit 206 to also be produced by the chip manufacturer. The CAPI authentication routine is authenticated by means of the boot ROM computer program code using the public key GROMPuK. The CAPI authentication routine contains the public key of the chip manufacturer for authentication of the CAPI (that is to say, for example, the public key IFXCAPIPuK). The boot ROM routine stored in the boot ROM memory 202 calls the CAPI authentication routine before the second-level boot routine of the mobile radio communication terminal manufacturer is called.

The second-level boot routine 610 is the first computer program code to be executed, which is read from the non-volatile random access memory 211 of the mobile radio communication terminal manufacturer, after the execution of the computer program code stored in the boot ROM memory 202 of the processor chip 200 and after the CAPI authentication routine has been executed completely.

The second-level boot process is executed only when the certificate tests which were carried out under the control of the boot ROM routine were successful. The second-level boot routine 610 is used for authentication of subsequent computer programs stored in the non-volatile random access memory 211. This results in a trustworthy chain of boot steps within the process of starting up the processor system 250. Further checks can be provided in the second-level boot routine. It should be noted that the second-level boot routine can, for example, use a unique value which, for example, is burnt into the electrical fuse links 208, in order to check the link between the content of the non-volatile random access memory 211 and the specific processor chip component.

The mobile radio communication terminal manufacturer optionally provides additional security checks such as the checking of the IMEI, or a check of the so-called SIMLock data. Furthermore, other additional security-relevant checks can be provided by application computer programs.

Once the processor system 250 has been reset, the processor system 250 is started up using the data stored in the non-volatile random access memory 211, although, in one alternative refinement of the invention, it is likewise possible for the starting up process to be carried out using data that is accessible by means of the serial interface, that is to say by way of example by means of USB or UART.

If the starting-up process has been carried out using data which is accessible by means of the serial interface 205, then the method is carried out in the same manner as that described above.

For example, a block “0” is loaded in the local memory unit 203 of the processor chip 200 by means of the serial interface 205, and is tested in the same manner as the block “0” in the non-volatile random access memory 211 in the exemplary embodiment described above, before the block “0” is executed.

Once the down-loaded computer program code has been checked, this can be used in order to update or else to repair the content of the non-volatile random access memory 211, in a reliable manner.

It should also be noted that, according to one exemplary embodiment of the invention, only the mobile radio communication terminal manufacturer can reprogram the program memory 211 by means of the serial interface 205. As soon as he has done this, the entire boot routine and the checks contained in it are carried out once again when the process system 250 is rebooted from the non-volatile random access memory 211.

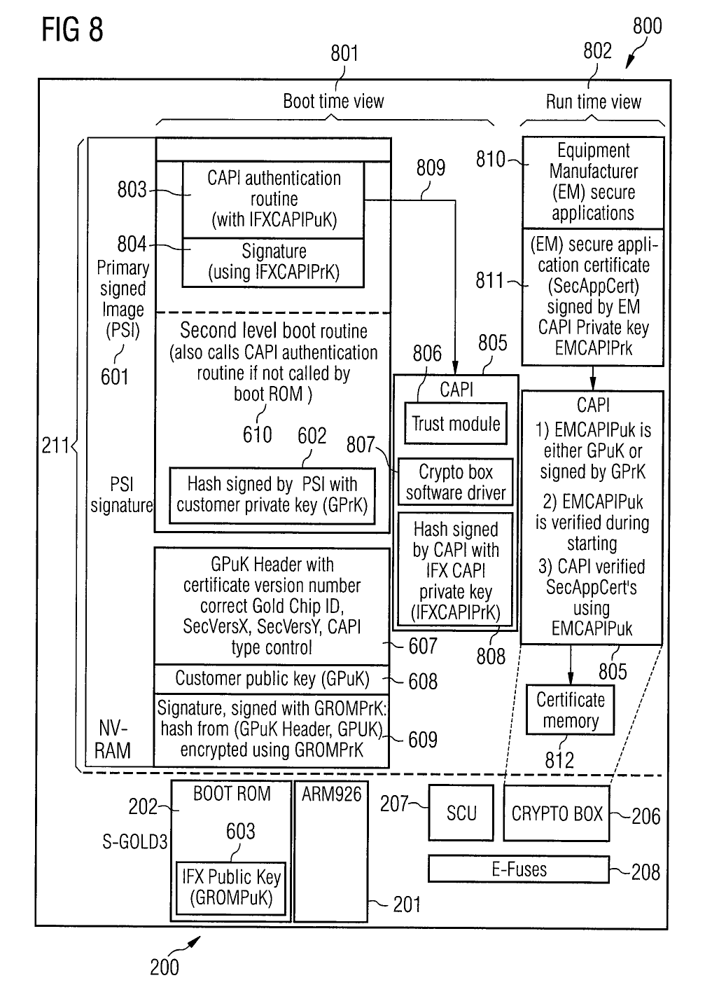

FIG. 8 shows a block diagram 800 illustrating an overview of the connection between the secure process of starting up the processor system 250 and the CAPI.

FIG. 8 illustrates the location at which the cryptographic certificates and keys are stored in the mobile radio communication terminal 100. The block diagram 800 is split into two views, a first view 801, also referred to as the start-up time view (boot time view 801), and a second view 802, also referred to as the operating time view (run time view 802).

As illustrated in the first view 801, the CAPI authentication routine 803 is stored in the PSI area 601, and contains the public key of the chip manufacturer, that is to say, for example, the public key IFXCAPIPuK.

Furthermore, a digital signature 804 is stored in the PSI area 601 using the CAPI authentication routine, having been formed using the secret chip manufacturer key, that is to say by way of example using the secret key IFXCAPIPrK.

Furthermore, the CAPI 805 which contains the computer program code for providing the trust module 806 described above, as well as the software driver 807 for the crypto unit 206, are stored in the non-volatile random access memory 211. Furthermore, this contains a hash value 808 which was formed using the CAPI 805 and was signed with the private chip manufacturer key for the CAPI, that is to say be way of example by means of the private key IFXCAPIPrK.

As can be seen from the first view 801 (symbolized there by means of an arrow 809), the CAPI 805 is executed first, once the CAPI authentication routine 803 has been successfully executed.

As is illustrated in the second view 802, provision is made during operation for the secure application computer programs 810 to be secured by means of appropriate cryptographic certificates, for example by means of the application computer program certificate SecAppCert 811 which, for example, is signed using the private key of the manufacturer or of the developer of the respective application computer program, or in other words using, for example, the private key EMCAPIPrK.

Only after the respective application computer program certificate has been successfully verified in the course of the CAPI 805 is the public key, associated with the private keys, of the developer or manufacturer of the application computer program verified, that is to say by way of example the public key EMCAPIPuK on startup, in which case, according to one exemplary embodiment of the invention, the public key EMCAPIPuK is, for example, the public key GPuK or, alternatively, the public key GPuK, signed using the private key GPrK.

Furthermore, the CAPI 805 verifies the respective application computer program certificate using the public key EMCAPIPuK. The respective application computer program certificate is stored in a certificate memory 812 in the non-volatile random access memory 211.

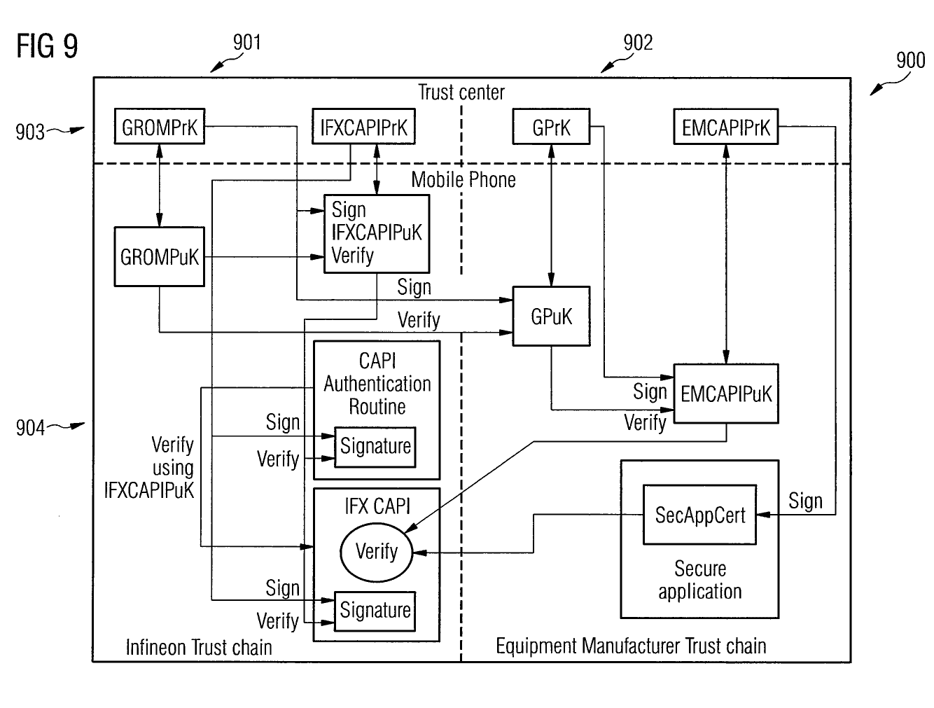

FIG. 9 shows a block diagram 900 of an overview of the relationships between the key pairs which are used for the purposes of the processor system 250.

The block diagram 900 is subdivided into four quadrants, with the left column 901 illustrating the chain of trust of the chip manufacturer, and the right-hand column 902 illustrating the chain of trust of the mobile radio communication terminal manufacturer. The keys which remain in the trust area are illustrated in an upper area 903 of the block diagram 900, and the relationships in the mobile radio communication terminal 100 are illustrated in a lower area 904.

One exemplary embodiment of the invention therefore ensures that only software with a valid certificate is allowed to access cryptographic functions provided by the crypto unit 206. The protective shield software, which for the purposes of this description is referred to as the crypto application programming interface CAPI, checks the respective certificate for an application computer program making a request for a cryptographic function of the crypto unit 206.

One exemplary embodiment of the invention provides a chain of trust which ensures that only certified application computer program manufacturers and developers may access the CAPI. Certified application computer program manufacturers or integrators, who are frequently the mobile radio communication terminal manufacturers or the network providers, have agreed the “dual-use” export regulations and therefore have an appropriate certificate.

The CAPI 805 is delivered from the exporting company, for example the processor chip manufacturer, and is authenticated cryptographically during startup of the processor system 205, or in other words a check is carried out to ensure that the CAPI 805 belongs to that platform and has not been changed without authorization.

It is also desirable for the integrator to ensure that the platform is started up securely, in order to prevent unauthorized modification of the platform. Split secure booting is provided according to one exemplary embodiment of the invention. This means that the platform exporter and the platform integrator can both carry out a secure start-up of their respective computer program code without the entire computer program code of the integrator having to be signed using private keys of the platform exporter, would be impracticable.

The split boot method allows the platform integrator to have complete control over the platform start-up process, and also makes it possible for the platform integrator to ensure that his software is integrated in the platform. The split boot method is controlled by means of the routine stored in the boot ROM memory 202, and which is stored in the embedded device, or in other words by way of example the processor chip 200.

It should be noted that the CAPI authentication which is provided for the platform integrator can run with the platform, that is to say also as a dedicated “secure execution” environment for the application processor. The CAPI could also be executed in this environment after startup, as a result of which the crypto unit, in other words by way of example the crypto hardware, is isolated from random access from an application by means of hardware.

One exemplary embodiment of the invention also allows the platform to be exported and to be used without the use of a secure boot method, for example during subsequent development phases and production phases of the processor system 250, and the associated application computer programs. When the platform is in this state, the cryptographic functions provided by the crypto unit 206 are not accessible. Only if the platform is configured such that a cryptographic public key-based secure boot method is carried out and, for example, the CAPI is therefore included in the processor system 250 are the cryptographic functions which are provided by the crypto unit 206 made available. In one exemplary embodiment of the invention, this configuration is achieved by means of irreversible electronic fuse links 208.

According to one exemplary embodiment of the invention, a public key of the platform exporter is used in hardware, that is to say stored in the boot ROM 202, as the root of the trustworthy method for secure booting.

The boot method is defined such that the platform integrator must have a public key which is digitally signed by the platform exporter in order to allow the secure booting function to be carried out. This last step makes it possible for the platform exporter to have control over which customers, that is to say for example which manufacturers or developers of application computer programs, can carry out secure booting on the platform and can thus use cryptographic functions using the crypto unit 206. This chain of trust allows fair export monitoring. In this context, fair means, for example, controllable and understandable by both parties, that is to say both for the processor system manufacturer, for example the manufacturer of the circuit arrangement, for example Infineon Technologies AG, and the application developer.

According to one exemplary embodiment of the invention, certified customers have the capability to use cryptographic hardware which is provided in the crypto unit 206 once secure booting has been successfully verified.

Furthermore, split secure booting makes it possible to ensure that the access control software is contained in the platform.

According to one exemplary embodiment of the invention, the access control software ensures that only application computer programs with a valid cryptographic certificate can access the cryptographic hardware, that is to say in other words the cryptographic functions provided by the crypto unit 206.

Furthermore, the platform integrated itself can certify application computer programs using a key which is certified by the platform integrator, although this does not comply with the “dual-use” export regulations in accordance with the Wassenaar Arrangement.

In this context, it should be noted that the public key GPuK may contain additional information, for example information relating to the action of the processor chip 200 with the PSI area 601 of the non-volatile random access memory 211. Furthermore, monitoring information may be included, for example monitoring information as to whether the user may create his own CAPI authentication routine.

One exemplary embodiment of the invention provides that it is not possible to interchange the keys which are used to form the first digital signature and the second digital signature. In order to ensure this, the associated public keys are checked before their use, by the boot ROM.

According to one exemplary embodiment of the invention, the CAPI and the CAPI authentication are implemented in different execution units. This means that the manufacturer of the platform and the manufacturer of the crypto software can each sign and protect their own code in such a way that only this code allows access to the cryptographic function (with suitable hardware support in the crypto unit). This results in a method for a manufacturer of a platform in order to supply certified code which cannot be changed by the platform integrator (a form of security system in a system).

This could include previous programming by means of melting of a secret fuse link key by the manufacturer of the platform, and delivery of an encrypted private key with the component. An end user or a third party can then be certain by means of a secure handshake method/protocol that the security software which is stored in the platform actually matches that from the manufacturer of the platform.

According to one exemplary embodiment of the invention, the chain of trust is actually split between the manufacturer of the platform and the platform integrator.

Another exemplary embodiment of the invention is directed at an application scenario which is based on a conventional business model of a prepaid mobile radio telephone. A technology has also recently been developed for prepaid computers, for example personal computers, work stations, or other computer platforms such as personal digital assistance (PDA) or other embedded computer devices such as computer devices for entertainment electronics, or consumer electronics.

While, in the case of a prepaid mobile radio telephone, it is possible to integrate a required usage license, restriction mechanisms or else access control mechanisms in a proprietary computer-based solution, for example in a proprietary chip which is not accessible outside the appliance (for example of a S-Gold chip series from the company Infineon Technologies AG), this is not possible in the case of devices which normally have a plurality of components such as a personal computer, a workstation, or some other computer platform such as a Personal Digital Assistant (PDA) or some other embedded computer devices. Owing to the complexity of, for example, a personal computer, and because of the use of different specific chips and different functional blocks, it is normally impossible to integrate mechanisms such as those mentioned above securely in a housing such as a single-chip solution or a multi-chip solution.

According to one exemplary embodiment of the invention, a circuit arrangement and a method are provided which allow the implementation of access control mechanisms and authentication mechanisms, for example for digital rights management purposes. Furthermore, this makes it possible to implement usage restrictions in standard computer platforms without having to modify relatively major functional blocks. The described exemplary embodiments represent suitable protection even against unauthorized rewiring or the formation of unauthorized (bypass) connections, and, at least reliably, identify unauthorized manipulation.

Conventionally, attempts have been made to counter the problems described above by implementing standard authentication and access control mechanisms (alternatively cryptographic methods) in the boot memory of the computer or in a computer program code which must be executed at important times or at important locations in the computer platform to be protected, for example at important points in the start computer program code (start-up computer program code) of the computer platform to be protected, for example the BIOS sequence.

Conventional attacks against protective measures such as those described above include, for example, replacement of the specific BIOS computer program code or of the BIOS access computer program code by a BIOS computer program code of an attacker or a BIOS access computer program code of an attacker which does not contain any access restrictions for the attacker. Alternatively, it was possible to delete the critical access control performance feature, for example by overwriting or replacing the original computer program code which contains the access restrictions.

This can be done, for example:
by replacing the computer program code memory chip (for example a ROM or the like) or the corresponding data storage medium;
by connecting an identical or similar memory in parallel with the important computer program code memory (for example by including it in the wiring of the host computer) and simply bypassing the corresponding memory access signals such as a conventional chip selection signal (chip select, CS) or memory read signal (RD);
by replacing or modifying parts of the computer program code by means of so-called programmable chips (for example application specific integrated circuits (ASCIC) or field programmable gate arrays (FPGA), etc.);
by reprogramming the memory chip or chips;
or by means of other suitable modification techniques.

In conventional approaches with the aim of countering the hazards and attacks described above, the normal aim is to provide hardware structures or software structures, or to design such hardware structures or software structures, with additional physical protection measures for which it is assumed that they cannot be modified, replaced or corrupted.

However, this procedure cannot be exploited to the full extent by virtue of one generally applicable principle:

Every structure designed by a person can also be modified or analyzed by a technique designed by a person.

One exemplary embodiment of the invention therefore provides for the problems described above to be solved in a different manner. One exemplary embodiment of the invention is based on the assumption that modifications can always be carried out. However, modifications such as these in data structures are detected and identified (for example during the starting-up process), and appropriate countermeasures can be introduced. If any differences or modifications are identified in the platform computer program code that is being used in comparison to the original platform computer program code, while the platform computer program code is being executed, then a restriction mechanism is provided, on the basis of which, for example, the host computer system is prevented from executing the platform computer program code or from processing platform computer program code data (that is to say it is stopped from doing so), or the host computer system functionality is reduced to a lower level, or to a lower performance. For example, provision is made for the entire computer device (for example the circuit arrangement) or one or more of its components to be switched off, its functionality to be reduced, or a step-by-step reduction to be provided in the functions.

One specific requirement according to one exemplary embodiment of the invention is that the described detection and countermeasure mechanism must be arranged and installed in such a way that it can likewise not be modified or replaced in a simple manner by an attacker. One exemplary embodiment of the invention therefore provides for the protective measures or protective mechanism to be arranged or to be installed close to or within the central important part of the computer platform to be protected (for example the central data processing unit to be protected, also referred to in the following text as the central processing unit CPU), for example in the form of one or more microprocessors, in general one or more computation units.

Computer platforms such as these (for the purposes of these exemplary embodiments this also refers to host computer systems) normally have one or more CPUs. Conventional protective mechanisms attempt to protect the physical data path to the CPUs.

According to one exemplary embodiment of the invention, a circuit arrangement is provided in which any change or any discrepancy in the incoming (loaded into the respective CPU) computer program code to be executed (also referred to as computer program code datastream) compared with a predefined reference is identified.

According to one exemplary embodiment, this is achieved on a reliable and verifiable basis by means of so-called integrity verification mechanisms using cryptographic methods such as the use of cryptographic hash algorithms.

In a cryptographic hash algorithm, a large amount of input data (in principle of any desired size) is combined and processed, and is “joined together” to form a single data block of output data, for example of a predetermined size, for example with a size of 256 bits, 512 bits, 1024 bits or the like (for example using the cryptographic hash algorithm SHA-256; alternatively, for example, it is possible to use the cryptographic hash algorithms SHA-1 or MD5, or alternatively any other suitable cryptographic hash algorithm). Even if only one bit in the input datastream (the input data) is changed, a large number of output data bits (for example approximately 50%) are changed when using a cryptographic hash algorithm such as this, thus indicating that the input data has been modified.

The output data from the cryptographic hash algorithm is, according to one exemplary embodiment of the invention, compared with a set of previously stored reference data items (which represent the “correct” hash value relating to the unmodified and therefore expected input data) and identifies a decision unit, and decides whether any discrepancy has appeared between the actual input data and the reference data. According to one exemplary embodiment, as the result of this comparison, the decision unit can decide which of the actions described above (for example deactivation of individual components or all of the components or, for example, reduction in the functionality of the computer system) should be implemented as a countermeasure and reaction to the identified modification of the input data.

One countermeasure that is provided in one exemplary embodiment of the invention is for the computer program code in the “corrupted” BIOS to be replaced by a reliable computer program code from the protected security controller. In one exemplary embodiment of the invention, this is achieved by the bus lines being rerouted or switched over, or by the desired drive signals according to the reliable computer program code being loaded directly in the cache memory of the one or more CPUs, for example using a test interface which is normally provided in per se in a CPU, and is integrated therein, such as the standard JTAG test bus.

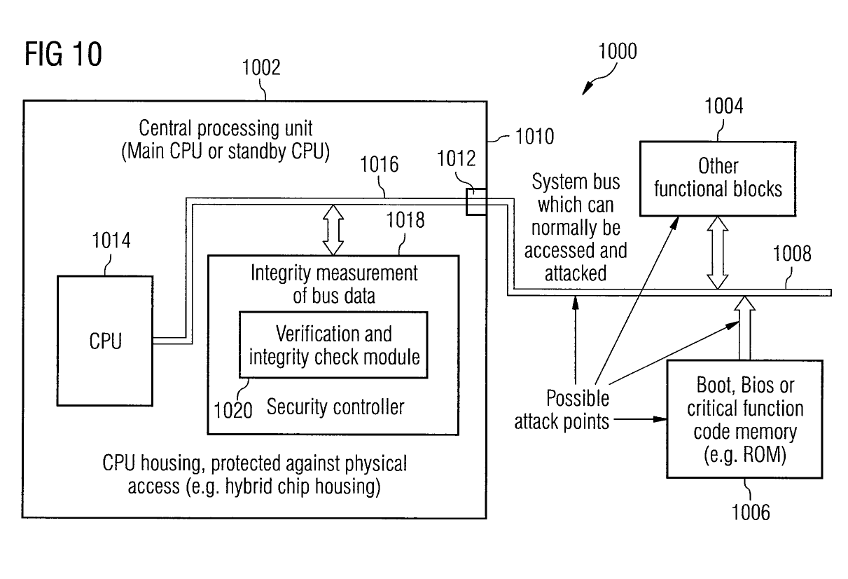

FIG. 10 shows a host computer system 1000 according to one exemplary embodiment of the invention. The host computer system 1000 has a central data processing unit 1002, one or more functional blocks which are formed by, for example, additional processors or memory units 1004, a BIOS memory 1006 which is in the form of a non-volatile memory, for example a read only memory (ROM) and in which, for example, a boot computer program code or BIOS computer program code, or some other computer program code which provides important functions for the central data processing unit 1002 (also referred to in the following text as the central processing unit, CPU) is implemented.

The CPU 1014, the functional units 1004 and the read only memory 1006 are connected to one another by means of a system bus 1008. The CPU is arranged in a housing 1010 which is coupled by means of a housing-external input/output interface 1012 to the system bus 1008. In addition to the CPU 1014, the housing 1010 may contain further processors, and possibly further central data processing units. Furthermore, a security controller 1018 is provided in the housing 1010, coupled to the CPU 1014 and to the input/output interface 1012 by means of an internal bus 1016, for example by means of the test standard bus JTAG, with the security controller 1018 being designed to provide cryptographic functions, for example to protect the integrity of the data transmitted by the system bus 1008, the input/output interface 1012 and the internal bus 1016 to the CPU 1014. According to one exemplary embodiment of the invention, the security controller 1018 is designed such that, for example, it provides the cryptographic security functions described above and in the following text, for example cryptographic hash functions for verification and integrity protection of the data supplied to the CPU 1014 via the internal bus 1016.

According to this exemplary embodiment of the invention, the data supplied to the CPU 1014 from the security controller 1018 is monitored by the internal bus 1016 and its integrity in comparison to the reference data stored in the security controller 1018 is checked using a cryptographic hash method. According to the invention, a verification and integrity test module 1020 is provided for this purpose in the security controller 1018, in which the hash functions and the test functions for integrity protection are carried out. The housing 1010 is protected against physical access via a different route than via the input/output interface 1012. The housing with the CPU 1014 may, for example, be in the form of a hybrid housing, that is to say a chip housing in which a plurality of chips is accommodated. As has been described above, according to one exemplary embodiment of the invention, when the start-up computer program code is being loaded in the CPU 1014 by means of the input/output interface 1012, the loaded start-up computer program code is read by the internal bus 1016 by means of the security controller 1018, and the start-up computer program code is used to form a hash value, for example with a size of 256 bits. This hash value that is formed is compared with a reference hash value (in general with reference data), with the reference hash value having been formed previously using the reliable original start-up computer program code, so that this results in integrity protection of the reliable original start-up computer program code to be protected.

As explained above, this makes it possible to identify a possible attack on the external system bus 1008 and possible modification of the start-up computer program code, alternatively of the BIOS program code or of some other critical computer program code, when the respective computer program code is supplied to the CPU 1014 by means of the security controller 1018, and take appropriate countermeasures, as described above.

It should be noted that, in one alternative embodiment of the invention, it is possible to provide for the hash value that is formed using the computer program code supplied to the CPU 1014 to also be stored in a memory in the security controller 1018 for subsequent analysis by means of another computer program which, for example, can be executed by the security controller 1018, the CPU 1014 or some other processor, in which case the computer program can be run on the same platform, that is to say from the host computer system 1002 or even a centralized integrity management server or a digital rights management server (DRM server).

Another embodiment of the invention provides for it to also be possible to integrate the cryptographic functions of the security controller 1018 in the CPU 1014 as an additional hardware module which is added in the course of the design of the microprocessor chip which is used as the CPU 1014. This saves an additional security controller 1018 in the form of a separate chip. In addition, when the functionality of the security controller 1018 is integrated in the CPU 1014, this makes it possible to achieve an even higher degree of security since, in this case, there would not be any prospect of success for an attacker just opening the housing 1010 of the host computer system 1002 and in this way possibly to bypass the internal bus 1016 and to feed the CPU 1014 directly with the “corrupted” control signals, that is to say the “corrupted” computer program code.

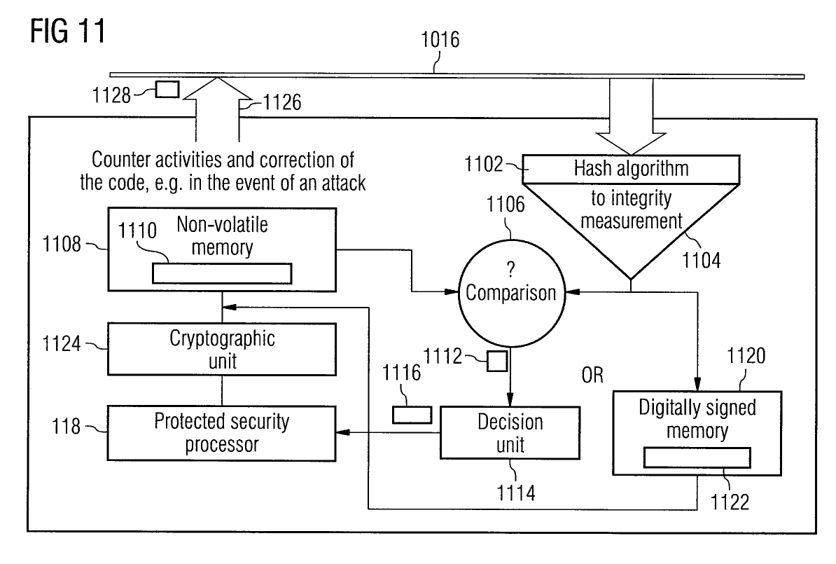

FIG. 11 shows the functionality of the security controller 1018 in a simplified form, as a flowchart.

The computer program code which is transmitted by the host-internal bus 1016 and is intended for the CPU 1014 is written to the security controller 1018 and is subjected to a cryptographic hash algorithm (symbolized by means of a block 1102 in FIG. 11), for example a cryptographic hash algorithm as described above.

The hash value 1104 that is formed is compared in a comparison step 1106 with a reference data item 1110 read from a non-volatile memory 1108.

The comparison result (for example a result that the two hash values match one another or that they differ) is supplied as a result signal 1112 to a decision unit 1114 which decides what measures must be provided on the basis of the result signal 1112 supplied to it.

In accordance with the intended countermeasure or countermeasures, in the event of a discrepancy between the measured and the newly formed hash value 1104 and the reference hash value 1110, the decision unit 1114 produces a control signal 1116 which is supplied to a protected and therefore “reliable” and trustworthy security processor 1118 for execution of a program code which represents the respective intended countermeasure.

Furthermore, the hash value 1104 is digitally signed and is stored as a digitally signed hash value 1122 in a further non-volatile memory 1120.

The described cryptographic algorithms that are provided, for example for determining the hash values or the respective digital signature, are carried out using a computer program code or a hash value that is formed, by means of one or more cryptographic units 1124.

The security processor 1118 produces the corresponding control signals 1128 for the CPU 1014 or for the other functional blocks 1004 at a second input/output interface 1126, with the control signals representing the countermeasures described above.

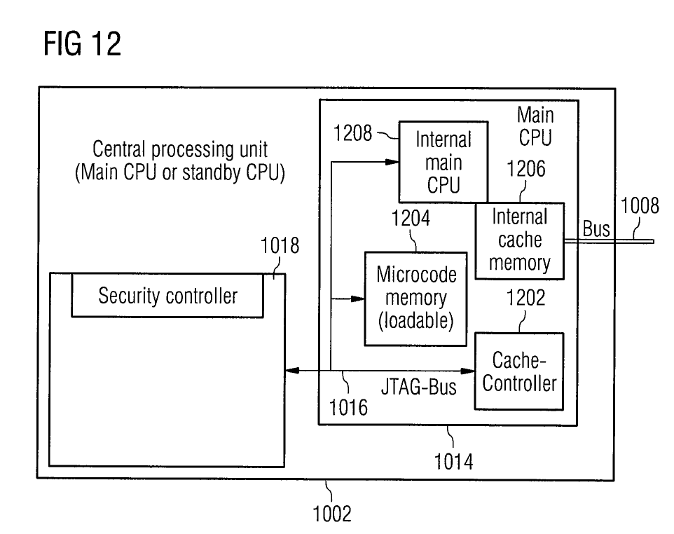

FIG. 12 shows the host computer system 1002 in greater detail.

The security controller 1018 is designed such that the start-up computer program code is loaded while starting up the host computer system 1002, and a hash value is calculated using this or using a part of the start-up computer program code, making use of a cryptographic hash function, as has been described above. The start-up computer program code is loaded, as has been described above, by reading the start-up computer program code from the internal bus 1016 which, for example, is in the form of a JTAG bus. Once the hash value has been formed, this is compared in order to ensure integrity with the already stored “reliable” reference hash value, which was previously formed using the original start-up computer program code. Then, as has been described above, a suitable countermeasure against an attack attempt is provided during the process of determining any discrepancy between these hash values, by the security controller 1018.

Another exemplary embodiment of the invention provides for the hash value that is determined to be stored, for example in a digitally signed form, in a trustworthy manner, and for the comparison described above with a reference hash value not to be carried out until a later time, with this comparison also being carried out by a different device (for example a trustworthy instance according to the TCG Standard (Trusted Computing Group)). The hash value that is determined, for example the digitally signed hash value that is determined, can be transmitted via a telecommunications network to a trustworthy instance.

According to one exemplary embodiment of the invention, the CPU 1114 has a cache memory controller 1202, which is coupled to the JTAG bus 1016, and a random access memory for storing the computer program code 1204.

Furthermore, an internal cache memory 1206 is provided, and is coupled to the system bus 1008.

Furthermore, a microprocessor 1208 is provided in the CPU 1014 and is coupled not only to the system-internal bus 1016 but also to the external bus 1008. According to this exemplary embodiment of the invention, the start-up computer program code which has been loaded in the random access memory 1204 for the CPU 1014 is accessed by means of the internal bus 1016 using the internal cache memory 1206 for the CPU 1014.

Modern CPUs 1014, such as a CPU from the company AMD or Intel, normally have an internal cache memory, which can be used by the CPU as a standard memory for storage of variables and computer program codes, executable codes, etc. and, possibly, a specific internal subprocessor which can be used to provide the security-relevant functions. Furthermore, the main processor 1208 of the CPU 1014 can also be used to execute the code stored in the cache memory 1206.

Using the JTAG Standard test bus, both data and computer program codes in order to ensure their integrity can be loaded in the internal cache memory 1206 while starting up the host computer system 1002, and can be supplied by means of the JTAG bus 1016 to the security controller 1018, in which the security measures described above are implemented. However, if the security-relevant functions are provided in the main CPU 1014, as described above in one alternative exemplary embodiment of the invention, provision is made for the computer program code to be loaded as a microcode in the random access memory 1204 for the CPU 1014, and for all of the measures to ensure integrity to be carried out on the basis of the data stored therein. Thus, it is made possible for the cryptographic functions to be carried out by the CPU 1208 itself, so that there is no need for any additional security controller 1018.

This may be desirable, for example, because a security controller 1018 normally has a large number of bus lines and thus a large number of input/output connections (for example 32 or 64 input/output pins), which would considerably increase the costs of the host computer system 1002.

The functions of the security controller 1018 may, for example, also be provided by the internal processor unit 1208.

The security controller 1018 is designed to carry out the following functions:

loading of the computer program code (for example of the microcode) and checking the integrity of the loaded computer program code, on the basis of an internal protected memory, while the host computer system 1002 is being started up;

synchronization, for example, of the computer program code, for example of the BIOS computer program code, while it is being executed, and ensuring its integrity;

storage and verification of the results of the integrity ensuring comparison; if any discrepancies are determined between the hash values, then the security controller 1018 selects and implements an appropriate countermeasure.

Technologies that are known per se, such as smart cards or trustworthy platform modules (trusted platform modules) can be used to provide the security controller 1018. Access control, updates, authentication and functions for controlling the security controller 1018 may in this case be implemented using currently available standards.

The reference hash value may, as has been described above, be digitally signed and may be stored in a protected memory area or in a separate memory (for example the further memory 1120), such that any modification of the reference hash value can be detected in a simple manner by checking the digital signature that is formed. Only software with a valid certificate is permitted according to one exemplary embodiment of the invention and allows access to the CPU 1014 and all of its functionality to be used. In this context, reference is made to specific implementation measures relating to the certificates and the respective computer subroutine to the exemplary embodiments described above, in conjunction with FIG. 1 to FIG. 9.

A further improvement can be achieved by installing an individual digital certificate in each verification module, for example in the trusted computing standard, and by the capability to load hash reference values securely from the external into the host computer system (in the case of an update to a function of the security controller). In these exemplary embodiments of the invention a chain of trust is designed such that only certified manufacturers of computer programs (for example application computer programs) such as DRM owners of the platform used can access the hash reference values, and can modify them, and, if appropriate, only they are allowed to add additional functions to the security controller and/or to the CPU 1014, or to delete or to modify existing functions.

According to one exemplary embodiment of the invention, and in an analogous manner to that described in conjunction with FIG. 1 to FIG. 9, provision is made for the host computer system to be started up in a split secure form. This means that the producer of the computer platform, for example of the host computer system 1002, as well as a certified customer service provider who maintains the host computer system and the platform DRM integrator and the DRM owner may all carry out secure start-up of the host computer system and may execute the computer program code in each case allocated to them and digitally signed by them, by supplying individual certificates, by means of a security device such as a smart card, to the security controller 1018 and to the cryptographic mechanisms provided in it.

The methods for split starting up of the host computer system make it possible for the DRM integrator to have complete control over the process of starting up the platform, but also makes it possible for the manufacturer of the platform to use his software that is associated with him to integrate the host computer system 1002, that is to say to maintain it and to complete it. The split starting-up process is controlled using the start-up computer program code stored in the start-up memory (boot ROM), in which case the start-up computer program code that is stored in the start-up memory is verified by means of an external authentication device. The start-up memory is provided in the security controller 1018.

One exemplary embodiment of the invention furthermore allows these protective measures and security features to be deactivated after a predetermined time period during operation or, for example, for the execution of application computer programs on the CPU 1014 to be deactivated after a predetermined useful life or after a predetermined number of calls, or else for the usage restrictions to be deactivated after a specific usage duration or after a specific number of calls to the respective computer application, in which case the user of the platform can use the application computer programs freely after paying a specific predeterminable fee.

According to one exemplary embodiment of the invention, a public key of the manufacturer of the host computer system can be used in hardware, for example in the start-up ROM of the security controller 1018, as a trustworthy start point for the security chain, for the purposes of the secure start-up process for the host computer system 1002.

According to one exemplary embodiment, the start-up process is defined such that the user of the platform must have a public key, which is signed by the platform supplier or the platform manufacturer digitally with his secret key in order to ensure secure startup of the host computer system 1002. The startup process is carried out in an appropriate manner, for example as has been described in conjunction with the exemplary embodiments in FIG. 1 to FIG. 9.

This makes it possible for the platform exporter or manufacturer of the platform to have control over which customer is permitted to carry out a secure startup with usage, associated with this, of all the functions of the host computer system 1002 on the platform.

In general, a predefined selection of functions intended for specific user groups can be provided using a secure start-up process such as this.

This makes it possible to use a computer platform such as the host computer system 1002 in different application scenarios and for different business models, since this makes it possible to provide a functionality of the host computer system 1002 that is scaled appropriately for the business model and/or is “tailor-made” for the application scenario on the basis of cryptographic mechanisms for different users.

What is claimed is:

1. A circuit arrangement, comprising:
at least one crypto unit configured to provide at least one cryptographic function; and
an access monitoring interface configured to check an access request from an application computer program to a cryptographic function of the crypto unit, wherein the access monitoring interface is configured such that:
it checks whether the application computer program is authorized to access the cryptographic function of the crypto unit, by checking whether the application computer program contains a valid certificate which allows that application computer program use of the cryptographic function,
if the application computer program is authorized to access the cryptographic function of the crypto unit, the cryptographic function is called, and
if the application computer program is not authorized to access the cryptographic function of the crypto unit, the access request is refused.

2. The circuit arrangement as claimed in claim 1, further comprising:
an application processor configured to execute the application computer program.

3. The circuit arrangement as claimed in claim 1, further comprising:
a first boot memory configured to store a first partial boot routine that boots the circuit arrangement.

4. The circuit arrangement as claimed in claim 3,
wherein the boot memory is a read only memory.

5. The circuit arrangement as claimed in claim 3,
wherein at least one cryptographic function is also stored in the boot memory.

6. The circuit arrangement as claimed in claim 5,
wherein the at least one cryptographic function which is stored in the boot memory contains at least one of the following cryptographic functions: a symmetrical encryption function, an asymmetric encryption function, and a hash function.

7. The circuit arrangement as claimed in claim 1, further comprising:
a first key memory configured to store a first public key (GROMPuK) of a trustworthy instance.

8. The circuit arrangement as claimed in claim 1, further comprising:
fuse links which contain information about whether access to the crypto unit is possible.

9. A method for starting up a circuit arrangement, comprising:
checking whether a user who is starting up the circuit arrangement is authorized to use at least one function provided by the circuit arrangement; and
starting up the circuit arrangement, if the user is not authorized to use the at least one function provided by the circuit arrangement, in a first mode, in which the user has no access to the at least one function provided by the circuit arrangement.

10. The method as claimed in claim 9, further comprising:
starting up the circuit arrangement, if the user is authorized to use the at least one function provided by the circuit arrangement, in a second mode in which the user has access to the at least one function provided by the circuit arrangement.

11. A method for starting up a circuit arrangement, comprising:
checking whether a user who is starting up the circuit arrangement is authorized to use at least one cryptographic function provided by the circuit arrangement;
starting up the circuit arrangement, if the user is not authorized to use the at least one cryptographic function provided by the circuit arrangement, in a first mode in which the user has no access to the at least one cryptographic function provided by the circuit arrangement; and
starting up the circuit arrangement, if the user is authorized to use the at least one cryptographic function provided by the circuit arrangement, in a second mode, in which the user has access to the at least one cryptographic function provided by the circuit arrangement.

12. The method as claimed in claim 11,
wherein the process of checking whether the user who is starting up the circuit arrangement is authorized to use at least one cryptographic function provided by the circuit arrangement includes checking a certificate of a public key of the user.

13. The method as claimed in claim 11,
wherein the process of checking whether the user who is starting up the circuit arrangement is authorized to use at least one cryptographic function provided by the circuit arrangement comprises:
checking a second public key;
if the second public key is not valid, starting up the circuit arrangement in the first mode; and
if the second public key is valid, starting up the circuit arrangement in the second mode.

14. The method as claimed in claim 13,
wherein the process of checking whether the user who is starting up the circuit arrangement is authorized to use at least one cryptographic function provided by the circuit arrangement, comprises:
forming a hash value using at least the second public key;
reading a stored hash value using at least the second public key;
comparing the hash value that has been formed with the hash value that has been read;
if the two hash values do not match one another, starting up the circuit arrangement in the first operating mode; and
if the two hash values match one another, starting up the circuit arrangement in the second mode.

15. The method as claimed in claim 11,
wherein the process of checking whether the user who is starting up the circuit arrangement is authorized to use at least one cryptographic function provided by the circuit arrangement comprises:
checking a second digital signature which is formed using an item selected from the group consisting of: at least a part of a certificate of a public key, the public key, a first digital signature, and a partial boot routine;
if the second digital signature is not valid, starting up the circuit arrangement in the first mode; and
if the second digital signature is valid, starting up the circuit arrangement in the second mode.

16. A method for operating a circuit arrangement, comprising:
receiving an access request from an application computer program to a cryptographic function which is provided by the circuit arrangement;
carrying out a check to determine whether the application computer program is authorized to access the cryptographic function;
calling, if the application computer program is authorized to access the cryptographic function, the cryptographic function; and
refusing, if the application computer program is not authorized to access the cryptographic function, the access request.

17. A circuit arrangement comprising:
at least one first computation unit configured to execute at least one computer program;
an access monitoring interface unit configured to check an access request to the first computation unit;
an input/output interface which is shared by the first computation unit and the access monitoring interface unit; and
a computation-unit-external bus which is coupled to the input/output interface,
wherein the access monitoring interface unit is coupled to the input/output interface such that the access request is determined by it, and
wherein the access monitoring interface unit is configured such that:
it checks whether the access request satisfies a predetermined access criterion,
if the access request satisfies the predetermined access criterion, the first computation unit is allowed to process the access request, and
if the access request does not satisfy the predetermined access criterion, the access request is refused, or a predetermined action is carried out.

18. The circuit arrangement as claimed in claim 17,
wherein the access monitoring interface unit is a second computation unit.

19. The circuit arrangement as claimed in claim 17,
wherein the first computation unit is a programmable processor.

20. The circuit arrangement as claimed in claim 17,
wherein the first computation unit is contained in a first chip.

21. The circuit arrangement as claimed in claims 17,
wherein the access monitoring interface unit is a programmable processor.

22. The circuit arrangement as claimed in claim 17,
wherein the access monitoring interface unit is contained in a second chip.

23. The circuit arrangement as claimed in claim 22,
wherein the access monitoring interface unit is provided in a security controller for the second chip.

24. The circuit arrangement as claimed in claim 17, further comprising:
a computation-unit-internal bus,
wherein the first computation unit and the access monitoring interface unit are coupled to the computation-unit-internal bus.

25. The circuit arrangement as claimed in claim 24,
wherein the computation-unit-internal bus is designed in accordance with the JTAG Standard.
